(19) United States
(12) Patent Application Publication
(10) Pub. No.: US 2026/0010236 A1
(43) Pub. Date: Jan. 8, 2026

(54) USING A GESTURE TO INVOKE OR BANISH AN AI ASSISTANT, AND SYSTEMS AND METHODS OF USE THEREOF

(71) Applicant: Meta Platforms Technologies, LLC, Menlo Park, CA (US)

(72) Inventors: Scott Gary, Brooklyn, NY (US); Alexander Barte Binder, Oakland, CA (US); Jeffrey Mekler, Oakland, CA (US); Joseph Gardner, Burlingame, CA (US)

(21) Appl. No.: 19/258,803

(22) Filed: Jul. 2, 2025

Related U.S. Application Data
(60) Provisional application No. 63/667,112, filed on Jul. 2, 2024.

(51) Int. Cl. G06F 3/01; G06F 3/0481; G06F 3/0487; G06F 3/16

(52) U.S. Cl. CPC G06F 3/017; G06F 3/0481; G06F 3/0487; G06F 3/167

(57) ABSTRACT

One or more instructions executed by a wrist-wearable device and/or a head-wearable device is described herein. Instructions that, when executed by a wrist-wearable device and/or a head- wearable device worn by a user, cause the wrist-wearable device and/or the head-wearable device to perform or cause performance of one or more actions. The instructions further include capturing sensor data using sensors, initiating an assistant associated with the head-wearable device and/or wrist-wearable device. The instructions further include, in accordance with a determination that the hand gesture is no longer maintained, ceasing to capture sensor data via the sensors, and providing, by the assistant, a response to the user based on the sensor data. The response includes a characterization of a scene within the sensor data and a characterization of one or more objects within the sensor data.

### RELATED APPLICATION

This application claims priority to U.S. Provisional Application Ser. No. 63/667,112, filed Jun. 2, 2024, entitled “Using A Gesture to Invoke or Banish an AI Assistant, and Systems and Methods of Use Thereof,” which is incorporated herein by reference.

### TECHNICAL FIELD

This disclosure relates generally to use of virtual assistant at a wearable devices, including but not limited to techniques for invoking a virtual assistant at a wearable device (e.g., a wrist-wearable device, a head-wearable device, etc.) and capturing audio data and/or image data that can be used by the virtual assistant to provide feedback to a user of the wearable device, as well as improve user interactions at the wearable device.

### BACKGROUND

To initiate a virtual assistant or capture voice commands, existing devices require a user to provide a physical input at the devices (e.g., press of a physical button on a device), or actively capture audio data to detect trigger conditions. Physical inputs at a device require a user to have physical access to their device (or another device) which can cause a user to disengage from an activity or event and result in frustration over time. Alternatively, active audio captures can be invasive and inaccurate which can annoy and further frustrate a user. Further, the limited input methods of wearable devices and the lack of coordination between multiple input methods result in a slow and cumbersome user experience.

As such, there is a need to address one or more of the above-identified challenges. A brief summary of solutions to the issues noted above are described below.

### SUMMARY

The wrist-wearable devices, head-wearable devices, and methods of use thereof (as well as systems including both wrist-wearable and head-wearable devices) described herein address one or more of the above-mentioned drawbacks by seamlessly allowing a user to interact with a microphone and imaging sensor using gestures detected at a wrist-wearable device. In particular, the wrist-wearable device can cause one or coupled devices, such as a head-wearable device, to seamlessly activate one or more features associated with operating an imaging sensor and/or microphone and/or a virtual assistant at the wrist-wearable device and/or the head-wearable devices using one or more in-air hand gestures.

One example of computer system for invoking a virtual assistant is provided herein. The computer system includes a wrist-wearable device and/or a head-wearable device, and performs one or more of the following operations. The computer system, in accordance with a determination that a hand gesture performed by a user wearing the head-wearable device and the wrist-wearable device is maintained, captures sensor data using one or more sensors (e.g., an imaging sensor and/or audio sensor); initiates an assistant associated with the head-wearable device and/or wrist-wearable device; and provides an indication to the user that the assistant is using the sensor data. The computer system, in accordance with a determination that the hand gesture is no longer maintained, ceases to capture sensor data via the one or more sensors and presents, by the assistant, a response to the user based on the sensor data. The response includes a characterization of a scene within the sensor data and/or a characterization of one or more objects within the sensor data.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1F illustrate example inputs provided by a user via gestures to initiate an assistant, in some embodiments.

FIGS. 1G-1H illustrate examples of the virtual assistant UI element 165, in some embodiments.

FIGS. 2A-2F illustrate surface-contact gestures performed by a user 115, in accordance with some embodiments.

FIGS. 3A-3B illustrate example artificial-reality systems, in accordance with some embodiments.

FIG. 4A illustrates an example wrist-wearable device 400, in accordance with some embodiments.

FIG. 5A illustrates example head-wearable devices, in accordance with some embodiments.

FIG. 6A illustrates an example handheld intermediary processing device, in accordance with some embodiments.

FIG. 7 shows an example method flow chart for detecting inputs provided by a user via gestures to initiate an assistant, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging sensor of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging sensors, intermediary devices, and/or other devices described herein). Sensor data further includes context from digital information displayed on the screen of one of the devices (e.g., an open application), information about nearby devices based on wireless communication technologies, and other types of sensor data such as motion data, heath data, location, data, etc.

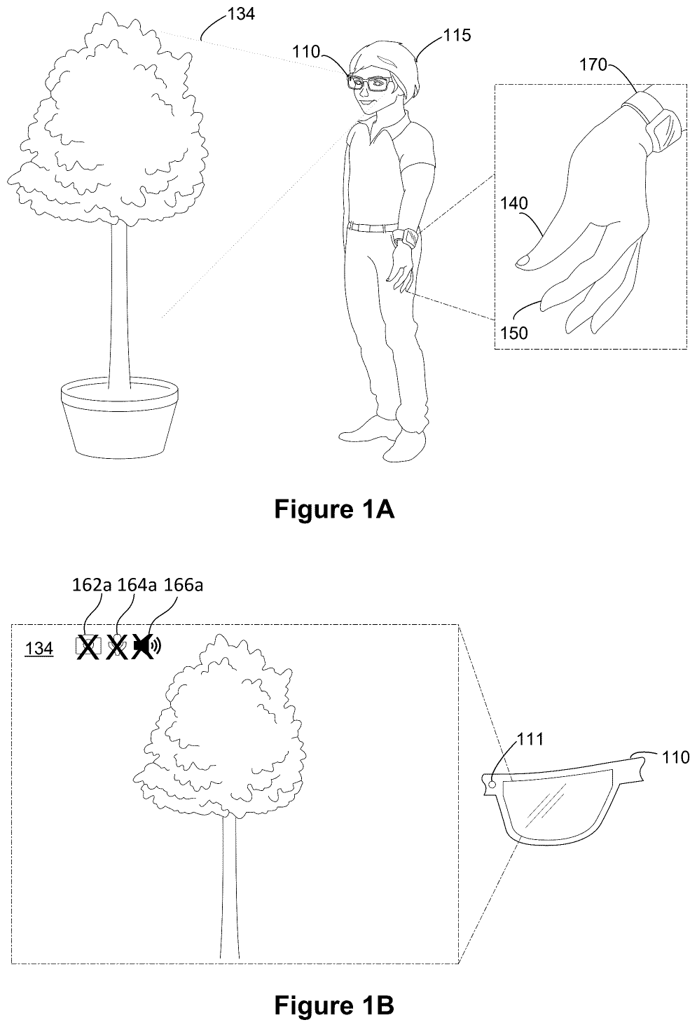

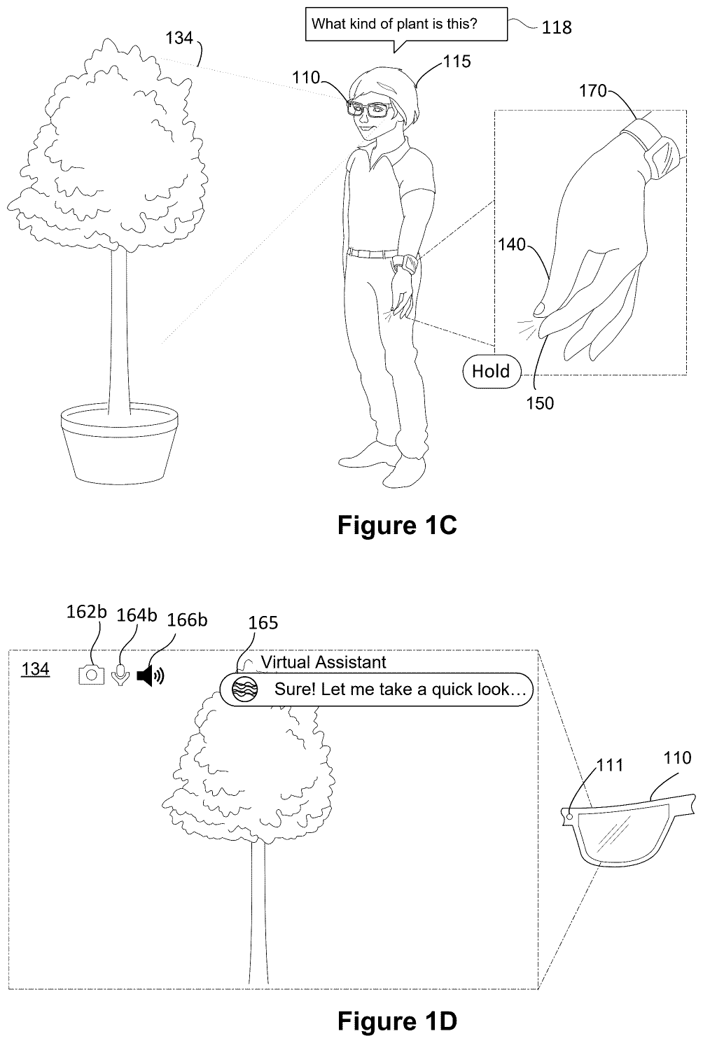

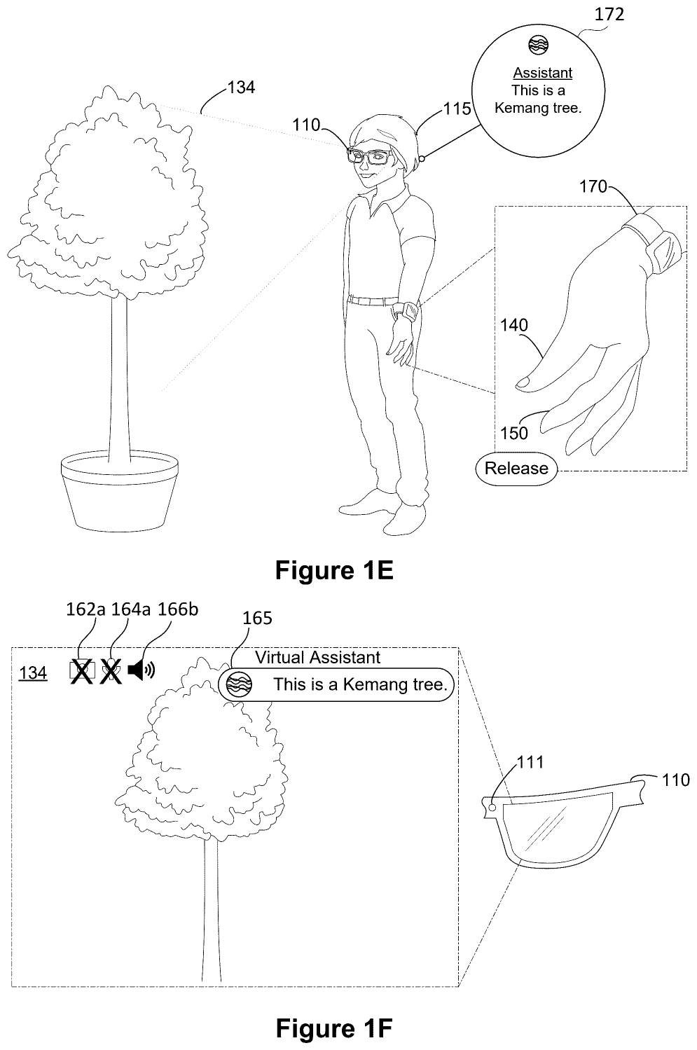

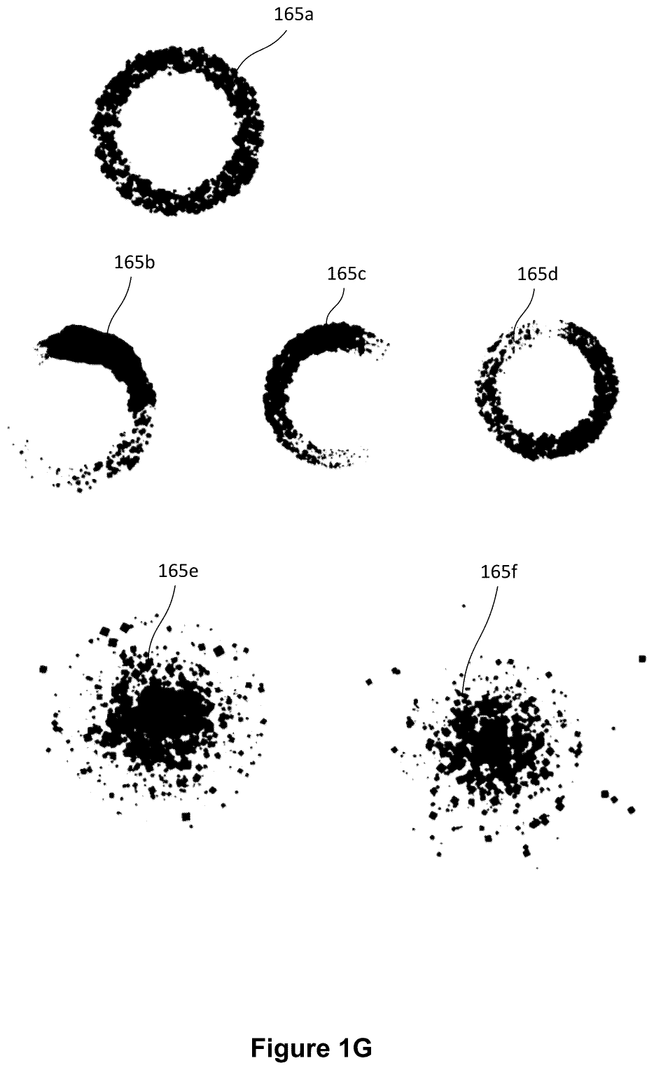

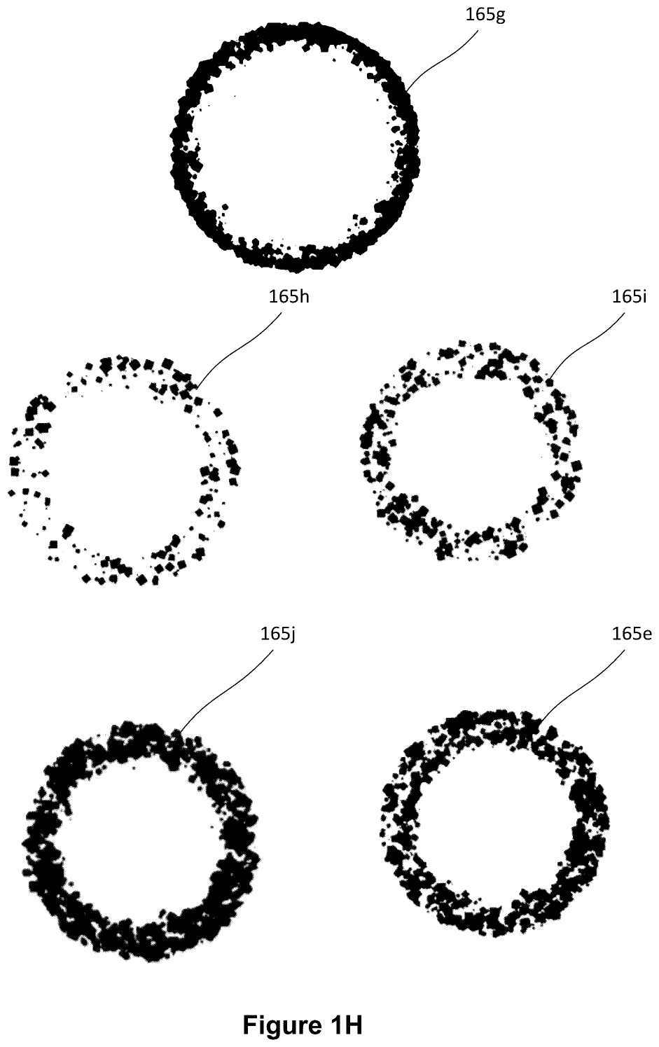

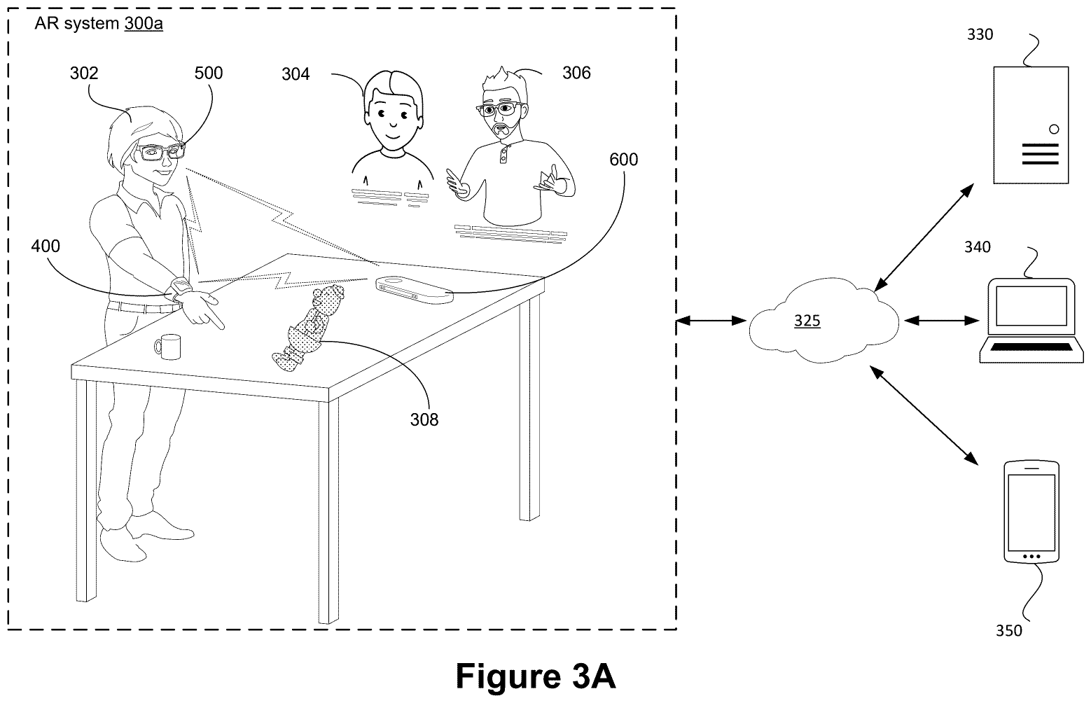

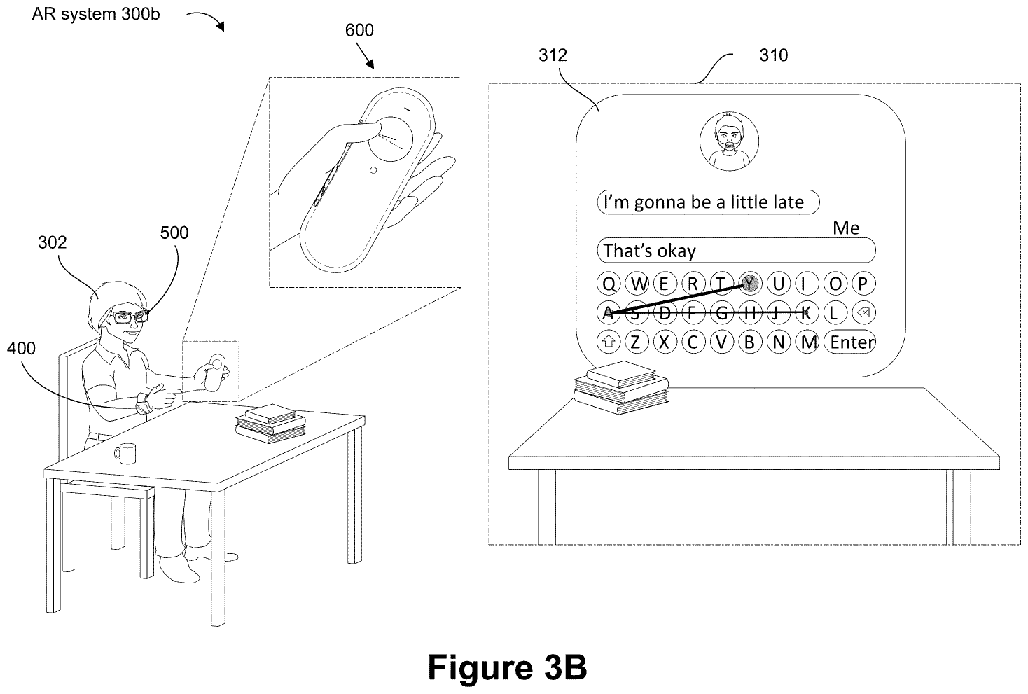

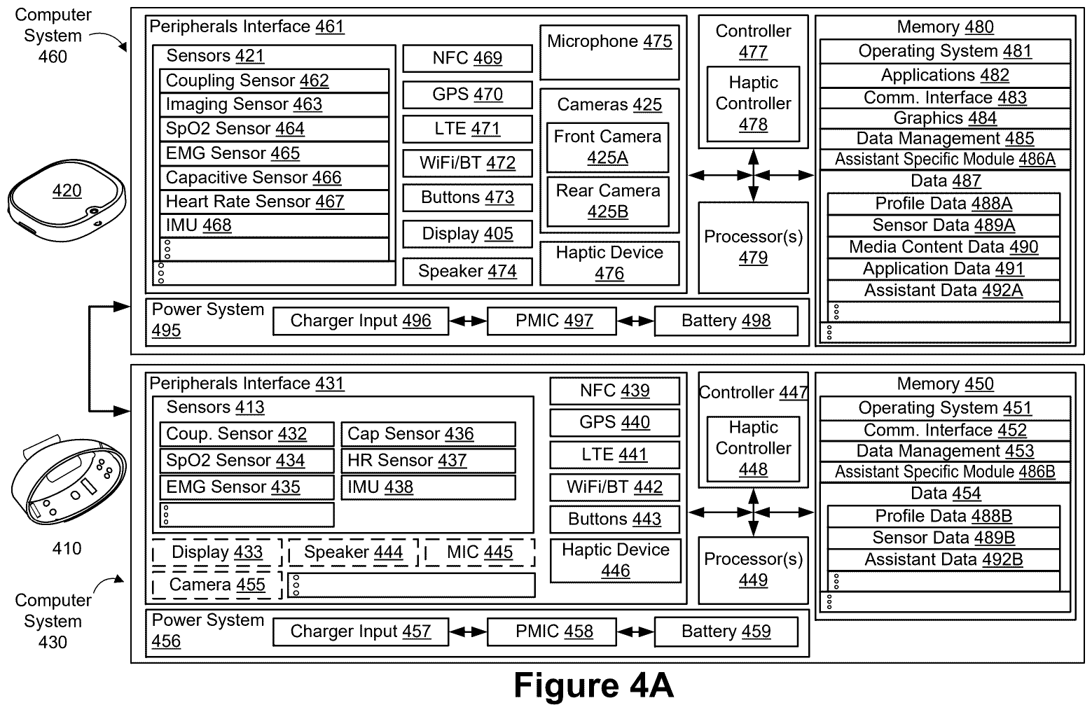

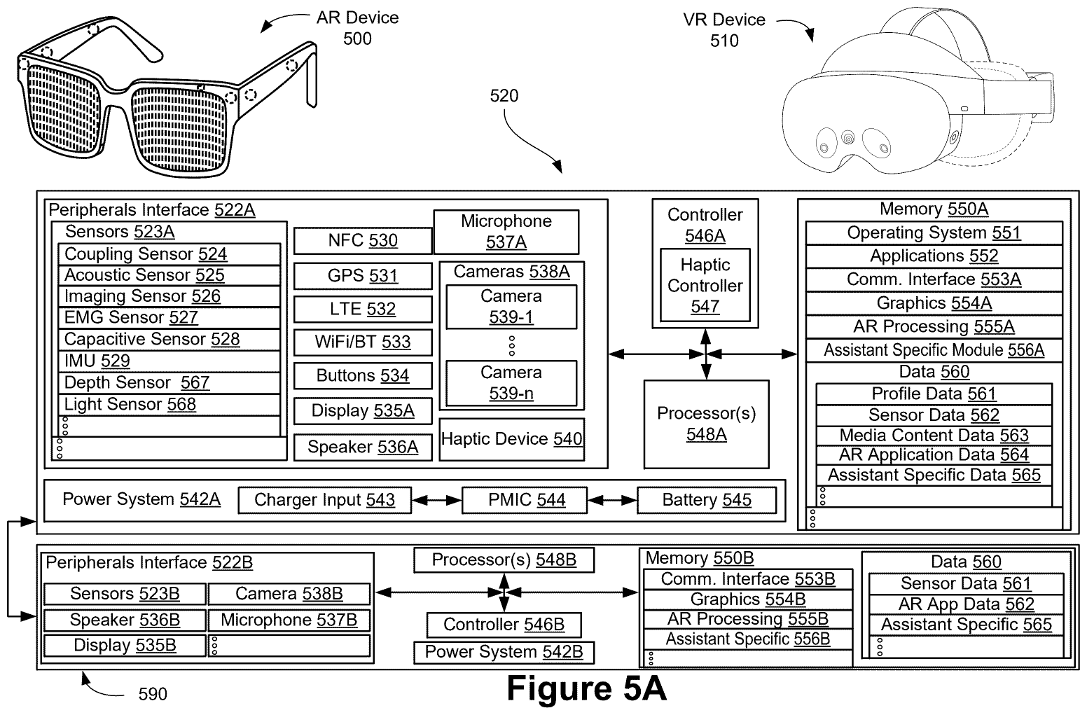

FIGS. 1A-1F illustrate an example computer system for invoking an assistant, in accordance with some embodiment. The computer system (also referred to as an artificial-reality system) of FIGS. 1A-1F shows example inputs (e.g., hand gestures) provided by a user 115 via a wrist-wearable device 170, a head-wearable device 110, and/or other communicatively coupled electronic device (e.g., an handheld intermediary processing device 600 or any other device described below in reference to FIG. 3A) to initiate an assistant (also referred to as an artificial-intelligence assistant or virtual assistant). The head-wearable device 110 and the wrist-wearable device 170 include one or more respective components described below in reference to FIGS. 4A-5A, such as displays, microphones (also referred to as audio sensors), speakers, imaging sensors, among other sensors and components described below.

As shown in FIGS. 1A and 1B, at a first point in time, the user 115 wearing the wrist-wearable device 170 and the head-wearable device 110 is engaged with their environment. A field of view 134 of the user 115 is represented by dotted lines and partially presented in FIG. 1B. At the first point in time, the head-wearable device 110 and/or the wrist-wearable device 170 are not actively capturing audio data and/or image data and are not presenting audio data (e.g., represented by deactivated imaging sensor UI element 162a, deactivated microphone UI element 164a and deactivated speaker UI element 166a presented by the head-wearable device 110 and/or wrist-wearable device 170).

As discussed below, while a virtual assistant is active, the computer system can cause the head-wearable device 110 and/or wrist-wearable device 170 to present an indication that the virtual assistant is active. Similarly, in some embodiments, while the virtual assistant is inactive, the head-wearable device 110 and/or the wrist-wearable device 170 can present a virtual assistant UI element 165 (FIG. 1D) with a particular animation, a particular icon, and/or color. For example, when the assistant is not active, the head-wearable device 110 can present the virtual assistant UI element 165 with a sleeping animation, a gray icon, a white icon, or other inconspicuous color. Alternatively, in some embodiments, while the virtual assistant is inactive, the computer system can forgo presenting a virtual assistant user UI element 165.

Turning to FIGS. 1C and 1D, at a second point in time, in response to a hand gesture (e.g., a pinch and hold gesture, such as pinching of a first phalange 140 and second phalange 150, as shown in FIG. 1C) performed by the user 115, the computer system activates a virtual assistant at the wrist-wearable device 170 and/or head-wearable device 110 and captures, via sensors (e.g., an imaging sensor, a microphone, etc.) of the wrist-wearable device 170 and/or head-wearable device 110, audio data and/or image data. The virtual assistant and the sensors can remain active while the user 115 maintains the hand gesture. While the virtual assistant and the sensors are active, the user 115 is presented with an indication that the sensors and the virtual assistant are active (e.g., represented by activated imaging sensor UI element 162b, activated microphone UI element 164b, activated speaker UI element 166b, and virtual assistant UI element 165 presented by the head-wearable device 110 and/or wrist-wearable device 170).

In some embodiments, the captured audio data and/or image data are stored. Alternatively, in some embodiments, the captured audio data and/or image data are transient data (temporarily stored for analyses). The captured audio data and/or image data can be used by the virtual assistant (and/or as an associate AI model) for determining one or more responses to a user query and/or characterizing the captured audio data and/or image data. For example, as shown in FIG. 1B, audio data and image data captured while the hand gesture is maintained can be used by the virtual assistant to determine a response to the use query (e.g., detecting a user query “What kind of plant is this?” and associating the user query with the captured image of a plant within the field of view 134 of the user 115). The virtual assistant (and/or as an associate AI model) can determine whether the captured audio data and/or image data are relevant to one another when determining a response. In situations where the captured audio data and/or image data are not relevant to one another, the virtual assistant (and/or as an associate AI model) use relevant portions of the captured audio data and/or image data to determine a response. For example, the virtual assistant (and/or as an associate AI model) receiving a user query requesting for an internet search of the top song today would not use the image data of the field of view 134 of the user 115 to prepare a response.

In some embodiments, audio data includes sounds other than the user 115's voice such as voices or other individuals (e.g., announcements at an airport) and/or sounds of nature (e.g., rain, thunder, trees in the wind, etc.) and the image data includes additional contextual data that is not the focus of the capture (e.g., background images or objects). The virtual assistant (and/or as an associate AI model) in detecting a user query and determining a response can analyze all available data to determine context and characteristics of a user query and prepare a response for the user 115.

In some embodiments, the computer system provides, via the head-wearable device 110 and/or the wrist-wearable device 170, an indication that the virtual assistant is using the sensor data (e.g., the captured audio data and/or image data). For example, the indication can be a virtual UI element 165 and/or an audio cue (e.g., presentation of “Sure! Let me take a quick look . . . ” via a speaker). In some embodiments, the computer system provides the user 115 one or more audio, visual, and/or haptic responses to indicate that one or more types of sensor data are being captured. For example, as described above, different UI elements can be presented to the user 115 via the head-wearable device 110 and/or the wrist-wearable device 170. Although not shown, the user 115 can receive haptic responses indicating that the virtual assistant is active and/or the sensor data is being captured. In some embodiments, the user 115 can receive an audio notification of the type of sensor data being captured (e.g., a speaker providing a notification that an imaging sensor is active). As discussed previously, while the virtual assistant is active, the head-wearable device 110 and/or the wrist-wearable device 170 can display the virtual assistant UI element 165. In some embodiments, the virtual assistant informs the user 115 that the sensor data is being captured. Alternatively or in addition, in some embodiments, the user 115 is notified that sensor data is being captured and/or that the virtual assistant is active via one or more light sources (e.g., single colored or multi-colored light-emitting diodes) on a portion of the head-wearable device 110 and/or wrist-wearable device 170.

The different indications and/or notifications are configured to be subtle and non-intrusive such that the user 115 is aware of the operations being performed by the wearable devices but not disengaged from real-world activities.

FIGS. 1E and 1F illustrate the user 115 at a third point in time. In FIGS. 1E and IF the user 115 releases the maintained hand gesture (e.g., the pinch and hold gesture) detected by the wrist-wearable device 170 and/or head-wearable device 110. The computer system, in response to detecting that the user 115 released the maintained hand gesture, ceases capturing audio and/or image data via the head-wearable device 110 and the wrist-wearable device 170. Additionally, the computer system, in response to detecting that the user 115 released the maintained hand gesture, uses the virtual assistant (and/or as an associate AI model) to generate and provide a response to the user 115 via the head-wearable device 110 and the wrist-wearable device 170. More specifically, when the user 115 releases the maintained hand gesture, the virtual assistant (and/or as an associate AI model) ceases to receive image data and/or audio data and determines a response based on the image data and/or audio data obtained while the hand gesture was maintained. For example, the virtual assistant provides an audio and visual response “This is a Kemang tree” in response to the earlier query provided by the user 115 asking “what kind of plant is this?”

The virtual assistant response can be provided as a first assistant notification 172 (e.g., an audible response to the user's 115 query) and/or the virtual assistant UI element 165 (e.g., a visual response to the user's 115 query). As further shown in FIG. 1F, when the maintained hand gesture is released, an indication is provided that the imaging sensor and the microphone are not active (e.g., not capturing audio data and/or image data). In some embodiments, the virtual assistant can provide a visual cue at another communicatively coupled device, such as the display of a wrist-wearable device, smartphone, or other device. Additionally, the field of view 134 can include one or more user interface elements that allow the user 115 to share the captured sensor data via a post, to other users, etc. For example, the virtual assistant can provide a user interface element configured to share a captured image via a text message with another user, or to post the captured image to a social media site.

After the virtual assistant provides the response to the user 115, the virtual assistant is deactivated. The user 115 can perform another hand gesture (e.g., a subsequent pinch and hold gesture) to provide an additional query and/or additional image data to the virtual assistant (and/or as an associate AI model).

FIGS. 1G-1H illustrate examples of the virtual assistant UI element 165, in some embodiments. In some embodiments, the virtual assistant UI element 165 appears geometrically shaped (e.g., a circle) that includes one or more smaller elements (e.g., other shapes such as triangles, squares, more circles, etc.) that increase in number and/or change colors based on the query asked, the density of the data, or depending on what state the virtual assistant is in (e.g., thinking, answering, etc.). Turning to 1G, for example, virtual assistant UI element 165a, which is a full circle of elements, is displayed while the virtual assistant in a neutral state (e.g., prior to being activated such as in FIG. 1A).

Virtual assistant UI elements 165b-d illustrates an example of what the virtual assistant UI element 165 looks like while the virtual assistant is activated and gathering sensor data (e.g., audio data). For example, while the user 115 is maintaining the pinch gesture to activate the virtual assistant (e.g., as illustrated in FIG. 1C), the virtual assistant UI element 165 can rotate through virtual assistant UI elements 165b-d to show a focus point traveling in a circle with the one or more smaller elements following the focus point. In some embodiments, the focus point continues to travel in a circle as long as the user 115 maintains the pinch gesture.

Virtual assistant UI elements 165e-f illustrate an example of what the virtual assistant UI element looks like while the virtual assistant is processing the sensor data after the user 115 has asked their query and released the pinch and hold gesture, as illustrated in FIGS. 1C-1D. While the system is processing the sensor data, the one or more elements appears as a collection fluctuating from a small sphere to a larger sphere. For example, virtual assistant UI element 165e illustrates the slightly larger sphere with more smaller elements inside of an outer perimeter and virtual assistant UI element 165 illustrates a slightly smaller sphere that has smaller elements condensed closer to the middle with a few loose, small elements scattered outside of the smaller sphere perimeter.

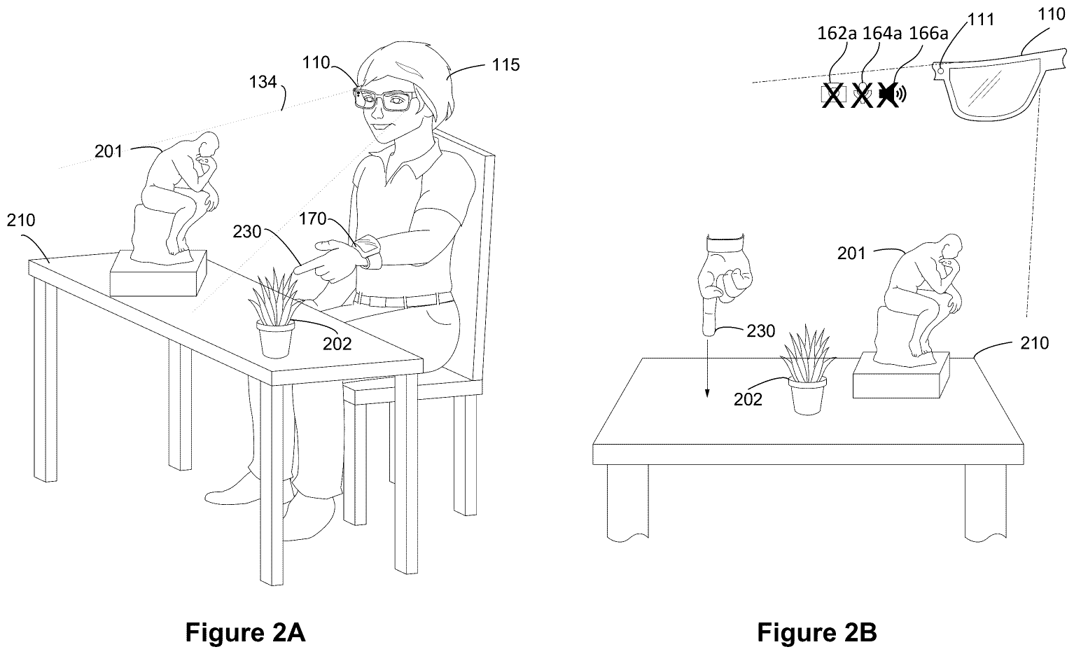

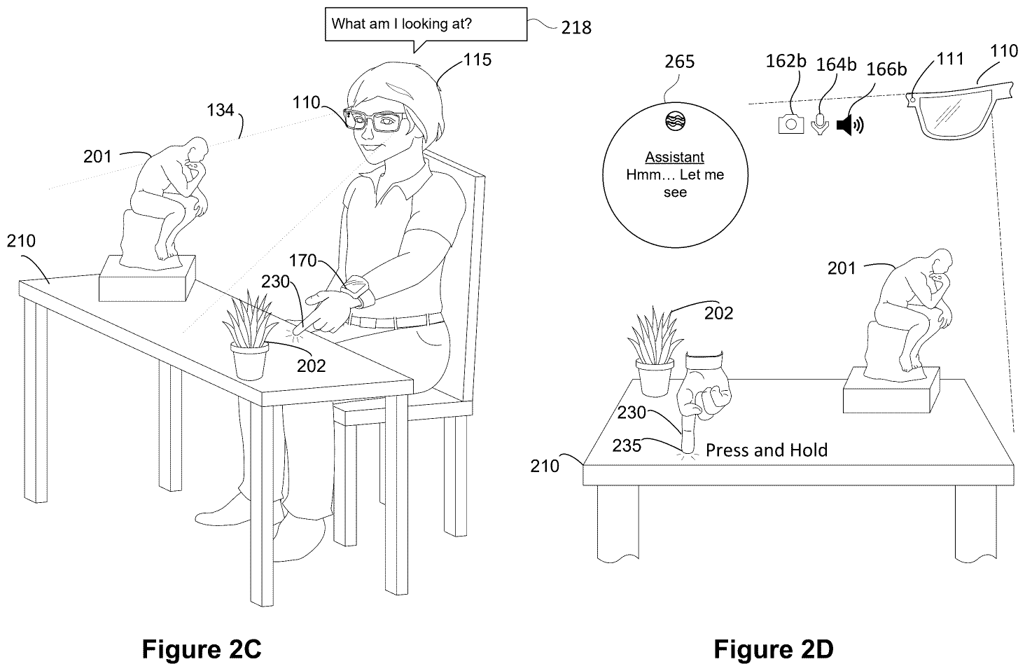

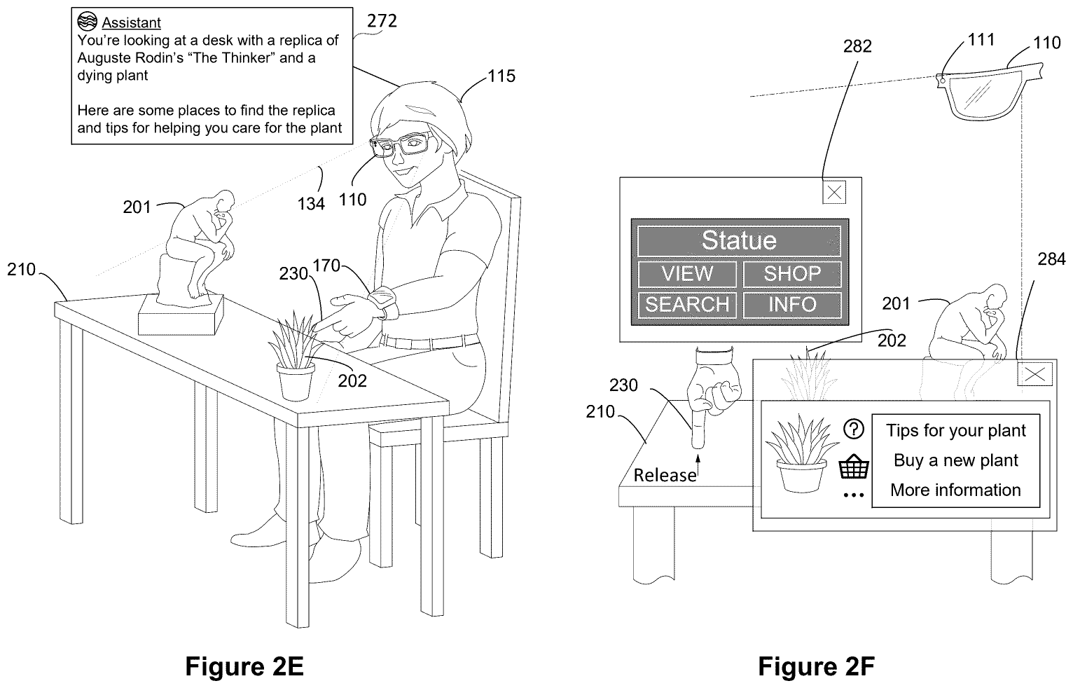

Turning to 1H, while the virtual assistant is providing an answer to a user's query (e.g., as illustrated in FIGS. 2E) the virtual assistant UI element 165g presents itself in a circular pattern similar to the neutral state but a slightly thinner circle, distinct from the neutral state. Virtual assistant UI elements 165h-j illustrate the virtual assistants depth of knowledge based on the density of the smaller elements in the virtual assistant UI element 165. For example, when the virtual assistant has a lower level of knowledge, the small elements will look dim and sparse (e.g., as illustrated by virtual assistant UI element 165h) but as the virtual assistant has more knowledge, the virtual assistant UI element 165 gets brighter and has a higher density of small elements. For example, a medium level of knowledge is indicated with virtual assistant UI element 165i with a slightly higher density of small elements and a high level of knowledge is indicated in virtual assistant UI element 165j with a much brighter circle and higher density of smaller items. Virtual assistant UI element 165e illustrates a change in small element color density based on the primary usage of specific application. For example, if a messaging application is primarily used, the virtual user interface element 165e can include a higher density of small elements in a first color (e.g., green) and if a social networking based application is primarily used, the virtual user interface element 165e can include a higher density of a second color of small elements (e.g., blue).

Although the examples of FIGS. 1A-1H describe the interaction between the wrist-wearable device 170 and the head-wearable device 110, hand gestures detected by the wrist-wearable device 170 can cause other communicatively coupled device to record, store and/or capture audio data, image data, present image data, and/or provide captured image data for presentation at communicatively coupled display.

FIGS. 2A-2F illustrate another example of a computer system invoking an assistant using surface-contact gestures performed by a user 115, in accordance with some embodiments. As described above in reference to FIGS. 1A-1F, the computer system can include a wrist-wearable device 170 and a head-wearable device 110 and/or any other device described below in reference to FIG. 3A (e.g., such as a handheld intermediary processing device 600). While the user 115 wears the wrist-wearable device 170 and the head-wearable device 110, sensor data is monitored to sense a surface-contact gesture performed by user 115. For example, when the user 115 moves a portion of his hand or intends to move a portion of his hand (e.g., phalanges 140, 150, etc.), the wrist-wearable device 170 detects position and/or orientation data as well as neuromuscular signals generated by the user 115's hand movement and contact with a surface 210 (e.g., a table). The sensor data used to detect and determine a surface-contact gesture can include image data from an imaging sensor 111 that is able to see the user 115's hand to use computer vision to detect gestures. The wrist-wearable device 170 uses and/or provides, to another device, sensor data associated with the surface-contact gesture to determine a type of surface-contact gesture performed by the user 115.

As shown in FIGS. 2A and 2B, at a first point in time, the user 115, while wearing the head-wearable device 110 and the wrist-wearable device 170, interacts with a physical environment, which includes a surface 210 (e.g., a table) and one or more objects (e.g., statue 201, plant 202, etc.). Similar to FIG. 1B, a field of view 134 of the user 115 is represented by dotted lines and partially presented in FIG. 2B. FIGS. 2A and 2B show the user 115's field of view before any surface-contact gesture is performed and detected by the wrist-wearable device 170. As described above in FIG. 1A and further illustrated in FIG. 2A, at the first point in time, the head-wearable device 110 and/or the wrist-wearable device 170 are not actively capturing audio data and/or image data and are not presenting audio data (e.g., represented by deactivated imaging sensor UI element 162a, deactivated microphone UI element 164a and deactivated speaker UI element 166a presented by the head-wearable device 110 and/or wrist-wearable device 170).

Turning to FIGS. 2C and 2D, at a second point in time, in response to a surface-contact gesture performed by the user 115 (e.g., pressing and holding phalange 230 on a surface as shown in FIG. 2C), the computer system activates the virtual assistant at the wrist-wearable device 170 and/or head-wearable device 110 and captures, via sensors (e.g., an imaging sensor, a microphone, etc.) of the wrist-wearable device 170 and/or head-wearable device 110, audio data and/or image data. In some embodiments, maintaining a surface-contact gesture can include holding a phalange or phalanges pressed against a surface for a predetermined period (e.g., two or more seconds). Alternatively or additionally, in some embodiments, maintaining a surface-contact gesture can include applying a predetermined threshold pressure between at least one phalange and a surface (e.g., a table, wall, palm, leg, etc.) for a predetermined period of time (e.g., at least two seconds). Similar to FIGS. 1C and 1D, the virtual assistant and the sensors remain active while the user 115 maintains the surface-contact gesture. While the virtual assistant and the sensors are active, the user 115 is presented with an indication that the sensors and the virtual assistant are active (e.g., represented by activated imaging sensor UI element 162b, activated microphone UI element 164b, activated speaker UI element 166b, and virtual assistant UI element 165 presented by the head-wearable device 110 and/or wrist-wearable device 170).

As shown in FIG. 2C, while the surface-contact gesture performed by the user 115 is maintained, audio data and/or image data are captured and used by the virtual assistant to determine a response to the user query and/or sent to a machine learning model for further analysis. FIG. 2C illustrates the virtual assistant activating and using captured image data and audio data in response to the user 115 maintaining the surface-contact gesture (e.g., pressing and holding phalange 230 on a surface) performed by the user 115. In response to performing the surface-contact gesture, the user 115 also asks another user query 218 requesting an analysis of the one or more objects (e.g., statue 201 and/or plant 202) within the field of view 134 of the user 115 (e.g., the user 115 asking “What am I looking at?”). The user query is captured in the audio data and related to the captured image data. The virtual assistant can use a machine learning model on a portion of the sensor data to analyze captured image data and/or audio data (including the other user query 218). In some embodiments, the other user query 218 is used to trigger the virtual assistant to perform a particular task (e.g., use the captured imaging data and/or audio data to perform a search, provide a description, and/or perform other analysis on the captured data). For example, a user query could include “what kind of statue is this?” which would cause the virtual assistant to identify a portion of the image data including the statue and analyzing the portions of the image data including the statue. In some embodiments, based on the user query, the virtual assistant forgoes utilizing portions of the captured image data. For example, responsive to the user query, “what kind of statue is this?”, the virtual assistant forgoes utilizing portions of the captured image data including the plant (e.g., as the query focuses on a different object not related to the plant).

FIG. 2D further illustrates the computer system providing, via the head-wearable device 110 and/or the wrist-wearable device 170, an indication that the virtual assistant is using the sensor data (e.g., the captured audio data and/or image data). For example, the indication can be a virtual UI element 265 and/or an audio cue (e.g., presentation of “Hmm Let me see” via a speaker).

FIGS. 2E and 2F illustrate the user 115, at a third point in time, ceasing to perform (e.g., releasing the gesture) the surface-contact gesture by removing their phalange 230 from the surface 210, detected by the wrist-wearable device 170 and/or head-wearable device 110. In response to the computer system (e.g., the wrist-wearable device 170, head-wearable device 110, and any other communicatively coupled device) detecting that the user 115 ceased maintaining the surface-contact gesture, the computer system ceases capturing audio data and image data. In some embodiments, when the surface-contact gesture is no longer detected, the user query 218 or a portion of the user query 218 is used for returning a response, from the virtual assistant, to the user 115. In other words, in response to the computer system detecting that the user released the surface-contact gesture, the computer system ceases providing the virtual assistant captured sensor data, and causes the virtual assistant to prepare a response to the user query based on the captured sensor data, and/or provides a second assistant notification 272 (which is an example of a response provided by the virtual assistant).

The response to the user query can include at least one of a characterization of the scene, a characterization of one or more objects, an explication the scene or additional information related to the scene. An explication and/or characterization of the scene further includes the process of analyzing and/or developing an idea or principal in detail. For example, an explication includes a detailed analysis of the process used to come to a solution provided to the user query in addition to the response that includes a recommendation and/or summary. Additionally, an explication can include information on the interaction between one or more objects, interactions between the scene and the objects, and/or a relationship to other images captured in a photo gallery, etc. In some embodiments, the response to the user query includes an assistant provided option (e.g., a user interface element or audible notification) for the user 115 to modify the sensor data. For example, if the user's audio was not clear (e.g., the user 115 mumbled) and/or the camera is covered or obstructed, the assistant can provide the user 115 with an opportunity to correct the sensor data by asking them to repeat themselves or removing the obstruction from the camera (via either a visual or audible notification).

FIG. 2E further illustrates the virtual assistant audibly providing the user 115 with a summary of the scene and a summary of the objects (e.g., a first type of response) including “You are looking at a desk with a replica of Auguste Rodin's ‘The Thinker’ and a dying plant.” In some embodiments, the system can provide multiple responses to the user 115 indicated in multiple ways (e.g., audibly, via the display of the head-wearable device 110 and/or the display of the wrist-wearable device 170).

FIG. 2F illustrates the field of view 134 of the user 115 in FIG. 2E. FIG. 2F further illustrates additional responses provided by the virtual assistant when the surface-contact gesture is released. Examples of the additional response based on the sensor data and user query include user interface elements, interactable objects, and/or other AR objects. For example, a first object user interface element 282 includes additional information related to statue 201 such as where the user 115 can view photos of the statue 201, where they can purchase a similar statue 201, additional information on the history and/or the artist of the statue, and an additional opportunity to view the statue 201 in other example locations via an internet photo search. In some embodiments, one or more user interface elements inside of first object user interface element 282 are selectable, allowing the user 115 to further choose what information on the statue 201 they would like to view. In some embodiments, a second object user interface element 284 includes one or more selectable user interface elements based on the plant 202 for the user 115 to get more information on tips to keep the plant alive, where to buy a new plant 202, or more information associated with the plant 202. In some embodiments, the information provided to the user 115 in the first object user interface element 282 and the second object user interface element 284 is provided to the user 115 audibly. Any number of additional user interface elements are created to provide a user 115 with more information on all objects in the scene. Additionally or alternatively, in some embodiments, the user interface elements can include description about interactions of objects and other pertinent information.

The virtual assistant is configured to deactivate when a detected user gesture (e.g., a hand gesture, surface-contact gestures, etc.) is no longer maintained. In this way, the virtual assistant operates in a to push-to-talk or walkie-talkie mode.

The above examples are non-limiting; the user 115 could perform a press and hold gesture 235 with other phalanges and is not only limited to the pointer finger (phalange 150) (e.g., could also be a thumb (phalange 140), middle finger, ring finger, pinky, two other fingers, etc.). Similarly, the different characteristics of a hand gesture (e.g., force, duration, number of contacts, etc.) can apply to surface-contact gestures, in-air contact gestures, and/or any other gestures detectable by the wrist-wearable device 170. Although the above-examples reference surface-contact gestures, difference in-air gestures and/or other gestures that do not contact a wrist-wearable device 170 are also contemplated for performing the different operations described in reference to FIGS. 2A-2F.

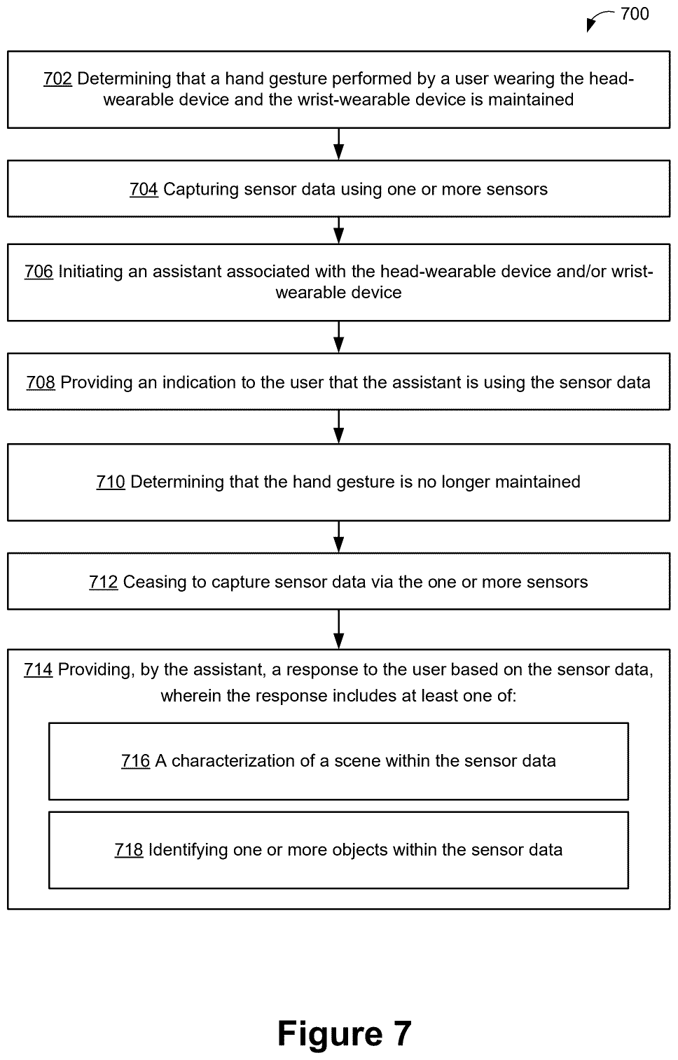

FIG. 7 illustrates a flow chart of an example method for performing operations described herein. Operations (e.g., steps) of the methods 700 can be performed by one or more processors (e.g., a central processing unit and/or an MCU) of AR device 500 and/or wrist-wearable device 400. At least some of the operations shown in FIG. 7 correspond to instructions stored in a computer memory or computer-readable storage medium (e.g., storage, RAM, and/or memory) of AR device 500 and/or wrist-wearable device 400 (e.g., memory 480, memory 450 or wrist-wearable device 400, and/or memory of the AR device 500). Operations of the method 700 can be performed by a single device alone or in conjunction with one or more processors and/or hardware components of another communicatively coupled device, such as AR device 500 and wrist-wearable device 400 device shown and described with respect to FIGS. 1A-2F. In some embodiments, the various operations of the methods described herein are interchangeable and/or optional, and respective operations of the methods are performed by any of the aforementioned devices, systems, or a combination of devices and/or systems. For convenience, the method operations will be described below as being performed by particular components and devices, but should not be construed as limiting the performance of the operation to the particular device in all embodiments.

(A1) FIG. 7 shows a flow chart of a method 700 of a computer system performing or causing the performance of one or more operations, in accordance with some embodiments. The method 700 occurs at the wrist-wearable device and/or head-wearable device (e.g., wrist-wearable device 170 and/or head-wearable device 110) with one or more imaging sensors, displays, etc. further described in FIGS. 4A-5A. In some embodiments, the method 700 includes, in accordance with a determination (702) that a hand gesture performed by a user wearing the head-wearable device and the wrist-wearable device is maintained.

The method 700 further includes, capturing (704) sensor data using one or more sensors (e.g., via imaging and/or audio sensors of the head-wearable device 110 and/or the wrist-wearable device 170), initiating an assistant (706) associated with the head-wearable device and/or wrist-wearable device, and providing (708) an indication to the user that the assistant is using the sensor data.

The method 700 further includes, in accordance with a determination (710) that the hand gesture is no longer maintained, ceasing (712) to capture sensor data via the one or more sensors, and providing (714), by the assistant, a response to the user based on the sensor data. Wherein the response includes one or more of i) a characterization (716) of a scene within the sensor data and ii) identifying (718) of one or more objects within the sensor data.

(A2) In some embodiments of A1, wherein the instructions, when executed by the computer system, further cause the computer system to perform one or more operations. The instructions further comprise before presenting the response to the user (e.g., user 115) based on the sensor data, generating the response using a model associated with the assistant, wherein the model is configured to receive a portion of the sensor data. For example, the model can include a machine learning model or large language model configured to process sensor data and determine a response provided to the user.

(A3) In some embodiments of A1-A2, wherein the instructions, when executed by the computer system, further cause the computer system to perform one or more operations. The one or more operations comprising presenting, via a display communicatively coupled with the wrist-wearable device and/or the head-wearable device, at least one user interface element, the at least one user interface element corresponding to one of performing an internet search on the sensor data, presenting a storefront associated with an object included in the sensor data, purchasing an object included in the sensor data, sharing the sensor data, modifying the sensor data, and storing the sensor data.

(A4) In some embodiments of A1-A3, wherein the response to the user further includes an explication of the scene and/or the one or more objects as the explication comprises an analysis of the scene and/or one or more objects and additional data stored at the wrist-wearable device and/or the head-wearable device. For example, an explication of the scene provides additional information beyond a description of the scene such as an analysis of an object in the scene, providing suggestions for how objects in the scene can work together, etc. For example, as shown in FIGS. 2A-2F the assistant identifies one of the objects as a plant and includes further analysis that the plant is a dying plant. The assistant further shows the user how they can care for the dying plant.

(A5) In some embodiments of A1-A4, wherein the instructions, when executed by computer system, further cause the computer system to perform or cause performance of one or more operations. The instructions further include presenting, via a display, a user interface element that when selected is configured to audibly narrate the response to the user via the assistant. For example, a user interface element is presented to a user 115 that when selected by the user 115 enables the assistant to provide the user 115 with audibly narrated indications in addition to and/or instead of displaying the indications.

(A6) In some embodiments of A1-A5, wherein the response to the user further includes sharing sensor data with an application in accordance with determination that the application is active while the user is performing the gesture. For example, if the user 115 is in a text messaging application, the assistant can share sensor data (e.g., a recorded voice message) via the messaging application.

(A7) In some embodiments of A1-A6, wherein the sensor data includes a user query (e.g., user query 118 or 218 as shown in FIGS. 1C and 2C). In some embodiments, a user query can include a command, requesting the system to look something up (e.g., “what plants are similar to an oak tree?”), asking a question (e.g., “what am I looking at?”), requesting research on an object/item in a scene a user 115 is looking at, etc.

(A8) In some embodiments of A1-A7, wherein providing an indication (e.g., a notification) to the user includes at least one of an auditory (e.g., via a virtual assistant and/or a speaker at the head-wearable device 110), a visual (e.g., via a user interface element), and/or a haptic indication (e.g., via the wrist-wearable device, head-wearable device, and/or another communicatively coupled device).

(A9) In some embodiments of A1-A8, wherein providing the response (e.g., response based on sensor data captured by the wrist-wearable device 170 and/or head-wearable device 110) to the user includes at least one of an auditory (e.g., via a virtual assistant and/or a speaker at the head-wearable device 110), a visual (e.g., via a user interface element), and/or a haptic indication (e.g., via the wrist-wearable device 170, head-wearable device 110, and/or another communicatively coupled device).

(A10) In some embodiments of A1-A9, wherein the hand gesture performed by the user is detected via one or more sensors (e.g., biopotential, EMG, IMU, etc.) coupled to the head-wearable device and/or wrist-wearable device.

(A11) In some embodiments of A1-A10, wherein the one or more sensors include at least one of a biopotential sensor (e.g., EMG, IMU), imaging sensor (e.g., camera, IR sensor, etc.), and/or audio (e.g., microphone) sensor.

(A12) In some embodiments of A1-A11, wherein capturing sensor data includes capturing imaging data and audio data. In some embodiments, capturing includes recording, storing, and/or analyzing the sensor data. Sensor data can be recorded at the wrist-wearable device and/or the head-wearable device simultaneously or independently. For example, the wrist-wearable device can capture audio data via a microphone while the head-wearable device captures imaging data via an imaging sensor 111. In another embodiment, the wrist-wearable device 170 can capture imaging data and audio data via sensors coupled to the wrist-wearable device 170 while the head-wearable device 110 also captures image data and audio data via sensors coupled to the head-wearable device 110.

(A13) In some embodiments of A1-A12, wherein the instructions, when executed by the wrist-wearable device and/or the head-wearable device worn by the user, further cause the wrist-wearable device and/or the head-wearable device to perform or cause performance of one or more actions. Before providing, by the assistant, the response to the user based on the sensor data, sending the sensor data to a machine-learning model configured to determine a response based on the sensor data. In some embodiments, the sensor data is sent to a machine-learning model for further analysis such that the response to the user 115 includes the analysis provided by the machine-learning model.

(A14) In some embodiments of A1-A14, wherein the instructions, when executed by the wrist-wearable device and/or the head-wearable device worn by the user, further cause the wrist-wearable device and/or the head-wearable device to perform or cause performance of providing an indication to the user that the assistant is using the sensor data. For example, as illustrated in FIGS. 1D and 2D, after the user has released the hand/surface-contact gesture, the virtual assistant provides an indication (e.g., “hmm . . . Let me see,” “Sure! Let me take a quick look . . . ,” etc.). An indication can include an audio indication, a haptic indication, and/or a visual indication (e.g., virtual assistant UI 165/265).

(B1) In accordance with some embodiments, a system that includes one or more wrist-wearable devices and an artificial-reality headset, and the system is configured to perform operations corresponding to any of A1-A13.

(C1) In accordance with some embodiments, a non-transitory computer readable storage medium including instructions that, when executed by a computing device in communication with an artificial-reality headset and/or a wrist-wearable device, cause the computer device to perform operations corresponding to any of A1-A13.

(D1) In accordance with some embodiments, a method of operating an artificial reality headset, including operations that correspond to any of A1-A13.

(E1) In accordance with some embodiments, a method comprising at a head-wearable device and/or a wrist-wearable device and in accordance with a determination that a hand gesture performed by a user wearing the head-wearable device and the wrist-wearable device is maintained, capturing sensor data using one or more sensors and initiating an assistant associated with the head-wearable device and/or wrist-wearable device. The method further includes providing an indication to the user that the assistant is using the sensor data and in accordance with a determination that the hand gesture is no longer maintained, ceasing to capture sensor data via the one or more sensors and providing, by the assistant, a response to the user based on the sensor data. The method further includes, wherein the response includes one or more of a characterization of a scene within the sensor data and an identification of one or more objects within the sensor data.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 400, a head-wearable device, an HIPD 600, a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems 3A-3B

FIGS. 3A-3B, illustrate example artificial-reality systems, in accordance with some embodiments. FIG. 3A shows a first AR system 300a and first example user interactions using a wrist-wearable device 400, a head-wearable device (e.g., AR device 500), and/or a handheld intermediary processing device (HIPD) 600. FIG. 3B shows a second AR system 300b and second example user interactions using a wrist-wearable device 400, AR device 500, and/or an HIPD 600. As the skilled artisan will appreciate upon reading the descriptions provided herein, the above-example AR systems (described in detail below) can perform various functions and/or operations described above with reference to FIGS. 1A-2F.

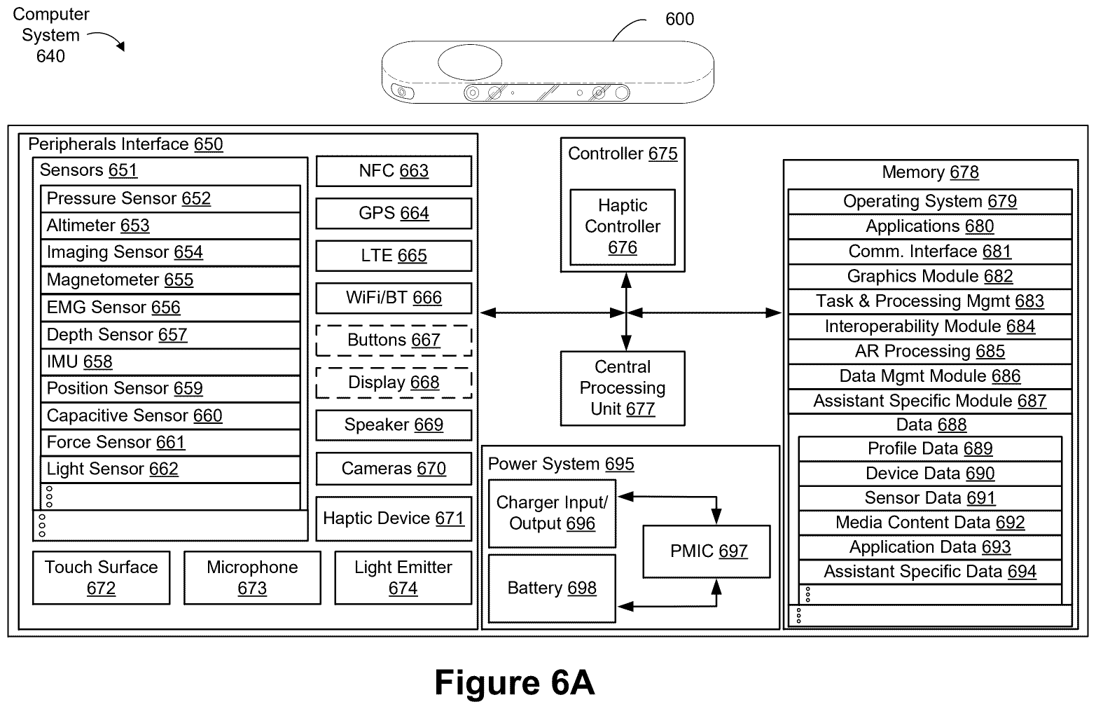

The wrist-wearable device 400 and its constituent components are described below in reference to FIG. 4A, the head-wearable devices and their constituent components are described below in reference to FIG. 5A, and the HIPD 600 and its constituent components are described below in reference to FIG. 6A. The wrist-wearable device 400, the head-wearable devices, and/or the HIPD 600 can communicatively couple via a network 325 (e.g., cellular, near field, Wi-Fi, personal area network, wireless LAN, etc.). Additionally, the wrist-wearable device 400, the head-wearable devices, and/or the HIPD 600 can also communicatively couple with one or more servers 330, computers 340 (e.g., laptops, computers, etc.), mobile devices 350 (e.g., smartphones, tablets, etc.), and/or other electronic devices via the network 325 (e.g., cellular, near field, Wi-Fi, personal area network, wireless LAN, etc.

Turning to FIG. 3A, a user 302 is shown wearing the wrist-wearable device 400 and the AR device 500, and having the HIPD 600 on their desk. The wrist-wearable device 400, the AR device 500, and the HIPD 600 facilitate user interaction with an AR environment. In particular, as shown by the first AR system 300a, the wrist-wearable device 400, the AR device 500, and/or the HIPD 600 cause presentation of one or more avatars 304, digital representations of contacts 306, and virtual objects 308. As discussed below, the user 302 can interact with the one or more avatars 304, digital representations of the contacts 306, and virtual objects 308 via the wrist-wearable device 400, the AR device 500, and/or the HIPD 600.

The user 302 can use any of the wrist-wearable device 400, the AR device 500, and/or the HIPD 600 to provide user inputs. For example, the user 302 can perform one or more hand gestures that are detected by the wrist-wearable device 400 (e.g., using one or more EMG sensors and/or IMUs, described below in reference to FIG. 4A) and/or AR device 500 (e.g., using one or more imaging sensors or cameras, described below in reference to FIG. 5A) to provide a user input. Alternatively, or additionally, the user 302 can provide a user input via one or more touch surfaces of the wrist-wearable device 400, the AR device 500, and/or the HIPD 600, and/or voice commands captured by a microphone of the wrist-wearable device 400, the AR device 500, and/or the HIPD 600. In some embodiments, the wrist-wearable device 400, the AR device 500, and/or the HIPD 600 include a digital assistant to help the user in providing a user input (e.g., completing a sequence of operations, suggesting different operations or commands, providing reminders, confirming a command). In some embodiments, the user 302 can provide a user input via one or more facial gestures and/or facial expressions. For example, cameras of the wrist-wearable device 400, the AR device 500, and/or the HIPD 600 can track the user 302′s eyes for navigating a user interface.

The wrist-wearable device 400, the AR device 500, and/or the HIPD 600 can operate alone or in conjunction to allow the user 302 to interact with the AR environment. In some embodiments, the HIPD 600 is configured to operate as a central hub or control center for the wrist-wearable device 400, the AR device 500, and/or another communicatively coupled device. For example, the user 302 can provide an input to interact with the AR environment at any of the wrist-wearable device 400, the AR device 500, and/or the HIPD 600, and the HIPD 600 can identify one or more back-end and front-end tasks to cause the performance of the requested interaction and distribute instructions to cause the performance of the one or more back-end and front-end tasks at the wrist-wearable device 400, the AR device 500, and/or the HIPD 600. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIG. 6A, the HIPD 600 can perform the back-end tasks and provide the wrist-wearable device 400 and/or the AR device 500 operational data corresponding to the performed back-end tasks such that the wrist-wearable device 400 and/or the AR device 500 can perform the front-end tasks. In this way, the HIPD 600, which has more computational resources and greater thermal headroom than the wrist-wearable device 400 and/or the AR device 500, performs computationally intensive tasks and reduces the computer resource utilization and/or power usage of the wrist-wearable device 400 and/or the AR device 500.

In the example shown by the first AR system 300a, the HIPD 600 identifies one or more back-end tasks and front-end tasks associated with a user request to initiate an AR video call with one or more other users (represented by the avatar 304 and the digital representation of the contact 306) and distributes instructions to cause the performance of the one or more back- end tasks and front-end tasks. In particular, the HIPD 600 performs back-end tasks for processing and/or rendering image data (and other data) associated with the AR video call and provides operational data associated with the performed back-end tasks to the AR device 500 such that the AR device 500 performs front-end tasks for presenting the AR video call (e.g., presenting the avatar 304 and the digital representation of the contact 306).

In some embodiments, the HIPD 600 can operate as a focal or anchor point for causing the presentation of information. This allows the user 302 to be generally aware of where information is presented. For example, as shown in the first AR system 300a, the avatar 304 and the digital representation of the contact 306 are presented above the HIPD 600. In particular, the HIPD 600 and the AR device 500 operate in conjunction to determine a location for presenting the avatar 304 and the digital representation of the contact 306. In some embodiments, information can be presented within a predetermined distance from the HIPD 600 (e.g., within five meters). For example, as shown in the first AR system 300a, virtual object 308 is presented on the desk some distance from the HIPD 600. Similar to the above example, the HIPD 600 and the AR device 500 can operate in conjunction to determine a location for presenting the virtual object 308. Alternatively, in some embodiments, presentation of information is not bound by the HIPD 600. More specifically, the avatar 304, the digital representation of the contact 306, and the virtual object 308 do not have to be presented within a predetermined distance of the HIPD 600.

User inputs provided at the wrist-wearable device 400, the AR device 500, and/or the HIPD 600 are coordinated such that the user can use any device to initiate, continue, and/or complete an operation. For example, the user 302 can provide a user input to the AR device 500 to cause the AR device 500 to present the virtual object 308 and, while the virtual object 308 is presented by the AR device 500, the user 302 can provide one or more hand gestures via the wrist-wearable device 400 to interact and/or manipulate the virtual object 308.

FIG. 3B shows the user 302 wearing the wrist-wearable device 400 and the AR device 500, and holding the HIPD 600. In the second AR system 300b, the wrist-wearable device 400, the AR device 500, and/or the HIPD 600 are used to receive and/or provide one or more messages to a contact of the user 302. In particular, the wrist-wearable device 400, the AR device 500, and/or the HIPD 600 detect and coordinate one or more user inputs to initiate a messaging application and prepare a response to a received message via the messaging application.

In some embodiments, the user 302 initiates, via a user input, an application on the wrist-wearable device 400, the AR device 500, and/or the HIPD 600 that causes the application to initiate on at least one device. For example, in the second AR system 300b the user 302 performs a hand gesture associated with a command for initiating a messaging application (represented by messaging user interface 312); the wrist-wearable device 400 detects the hand gesture; and, based on a determination that the user 302 is wearing AR device 500, causes the AR device 500 to present a messaging user interface 312 of the messaging application. The AR device 500 can present the messaging user interface 312 to the user 302 via its display (e.g., as shown by user 302's field of view 310). In some embodiments, the application is initiated and can be run on the device (e.g., the wrist-wearable device 400, the AR device 500, and/or the HIPD 600) that detects the user input to initiate the application, and the device provides another device operational data to cause the presentation of the messaging application. For example, the wrist-wearable device 400 can detect the user input to initiate a messaging application, initiate and run the messaging application, and provide operational data to the AR device 500 and/or the HIPD 600 to cause presentation of the messaging application. Alternatively, the application can be initiated and run at a device other than the device that detected the user input. For example, the wrist-wearable device 400 can detect the hand gesture associated with initiating the messaging application and cause the HIPD 600 to run the messaging application and coordinate the presentation of the messaging application.

Further, the user 302 can provide a user input provided at the wrist-wearable device 400, the AR device 500, and/or the HIPD 600 to continue and/or complete an operation initiated at another device. For example, after initiating the messaging application via the wrist-wearable device 400 and while the AR device 500 presents the messaging user interface 312, the user 302 can provide an input at the HIPD 600 to prepare a response (e.g., shown by the swipe gesture performed on the HIPD 600). The user 302's gestures performed on the HIPD 600 can be provided and/or displayed on another device. For example, the user 302's swipe gestures performed on the HIPD 600 are displayed on a virtual keyboard of the messaging user interface 312 displayed by the AR device 500.

In some embodiments, the wrist-wearable device 400, the AR device 500, the HIPD 600, and/or other communicatively coupled devices can present one or more notifications to the user 302. The notification can be an indication of a new message, an incoming call, an application update, a status update, etc. The user 302 can select the notification via the wrist-wearable device 400, the AR device 500, or the HIPD 600 and cause presentation of an application or operation associated with the notification on at least one device. For example, the user 302 can receive a notification that a message was received at the wrist-wearable device 400, the AR device 500, the HIPD 600, and/or other communicatively coupled device and provide a user input at the wrist-wearable device 400, the AR device 500, and/or the HIPD 600 to review the notification, and the device detecting the user input can cause an application associated with the notification to be initiated and/or presented at the wrist-wearable device 400, the AR device 500, and/or the HIPD 600.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 500 can present to the user 302 game application data and the HIPD 600 can use a controller to provide inputs to the game. Similarly, the user 302 can use the wrist-wearable device 400 to initiate a camera of the AR device 500, and the user can use the wrist-wearable device 400, the AR device 500, and/or the HIPD 600 to manipulate the image capture (e.g., zoom in or out, apply filters, etc.) and capture image data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIG. 4A shows block diagrams of a computing system 430 corresponding to the wearable band 410, and a computing system 460 corresponding to the watch body 420, according to some embodiments. The wrist-wearable device 400 is an instance of the wearable device 170 described in reference to FIGS. 1A-2F herein, such that the wrist-wearable devices should be understood to have the features of the wrist-wearable device 400 and vice versa. A computing system of the wrist-wearable device 400 includes a combination of components of the wearable band computing system 430 and the watch body computing system 460, in accordance with some embodiments.

The watch body 420 and/or the wearable band 410 can include one or more components shown in watch body computing system 460. In some embodiments, a single integrated circuit includes all or a substantial portion of the components of the watch body computing system 460 are included in a single integrated circuit. Alternatively, in some embodiments, components of the watch body computing system 460 are included in a plurality of integrated circuits that are communicatively coupled. In some embodiments, the watch body computing system 460 is configured to couple (e.g., via a wired or wireless connection) with the wearable band computing system 430, which allows the computing systems to share components, distribute tasks, and/or perform other operations described herein (individually or as a single device).

The watch body computing system 460 can include one or more processors 479, a controller 477, a peripherals interface 461, a power system 495, and memory (e.g., a memory 480), each of which are defined above and described in more detail below.

The power system 495 can include a charger input 496, a power-management integrated circuit (PMIC) 497, and a battery 498, each are which are defined above. In some embodiments, a watch body 420 and a wearable band 410 can have respective charger inputs (e.g., charger input 496 and 457), respective batteries (e.g., battery 498 and 459), and can share power with each other (e.g., the watch body 420 can power and/or charge the wearable band 410, and vice versa). Although watch body 420 and/or the wearable band 410 can include respective charger inputs, a single charger input can charge both devices when coupled. The watch body 420 and the wearable band 410 can receive a charge using a variety of techniques. In some embodiments, the watch body 420 and the wearable band 410 can use a wired charging assembly (e.g., power cords) to receive the charge. Alternatively, or in addition, the watch body 420 and/or the wearable band 410 can be configured for wireless charging. For example, a portable charging device can be designed to mate with a portion of watch body 420 and/or wearable band 410 and wirelessly deliver usable power to a battery of watch body 420 and/or wearable band 410. The watch body 420 and the wearable band 410 can have independent power systems (e.g., power system 495 and 456) to enable each to operate independently. The watch body 420 and wearable band 410 can also share power (e.g., one can charge the other) via respective PMICs (e.g., PMICs 497 and 458) that can share power over power and ground conductors and/or over wireless charging antennas.

In some embodiments, the peripherals interface 461 can include one or more sensors 421, many of which listed below are defined above. The sensors 421 can include one or more coupling sensors 462 for detecting when the watch body 420 is coupled with another electronic device (e.g., a wearable band 410). The sensors 421 can include imaging sensors 463 (one or more of the cameras 425 and/or separate imaging sensors 463 (e.g., thermal-imaging sensors)). In some embodiments, the sensors 421 include one or more SpO2 sensors 464. In some embodiments, the sensors 421 include one or more biopotential-signal sensors (e.g., EMG sensors 465, which may be disposed on a user-facing portion of the watch body 420 and/or the wearable band 410). In some embodiments, the sensors 421 include one or more capacitive sensors 466. In some embodiments, the sensors 421 include one or more heart rate sensors 467. In some embodiments, the sensors 421 include one or more IMUs 468. In some embodiments, one or more IMUs 468 can be configured to detect movement of a user's hand or other location that the watch body 420 is placed or held.

In some embodiments, the peripherals interface 461 includes an NFC component 469, a global-position system (GPS) component 470, a long-term evolution (LTE) component 471, and/or a Wi-Fi and/or Bluetooth communication component 472. In some embodiments, the peripherals interface 461 includes one or more buttons 473, which, when selected by a user, cause operations to be performed at the watch body 420. In some embodiments, the peripherals interface 461 includes one or more indicators, such as a light emitting diode (LED), to provide a user with visual indicators (e.g., message received, low battery, an active microphone, and/or a camera, etc.).

The watch body 420 can include at least one display 405 for displaying visual representations of information or data to the user, including user-interface elements and/or three-dimensional (3D) virtual objects. The display can also include a touch screen for inputting user inputs, such as touch gestures, swipe gestures, and the like. The watch body 420 can include at least one speaker 474 and at least one microphone 475 for providing audio signals to the user and receiving audio input from the user. The user can provide user inputs through the microphone 475 and can also receive audio output from the speaker 474 as part of a haptic event provided by the haptic controller 478. The watch body 420 can include at least one camera 425, including a front-facing camera 425A and a rear-facing camera 425B. The cameras 425 can include ultra-wide-angle cameras, wide-angle cameras, fish-eye cameras, spherical cameras, telephoto cameras, a depth-sensing cameras, or other types of cameras.

The watch body computing system 460 can include one or more haptic controllers 478 and associated componentry (e.g., haptic devices 476) for providing haptic events at the watch body 420 (e.g., a vibrating sensation or audio output in response to an event at the watch body 420). The haptic controllers 478 can communicate with one or more haptic devices 476, such as electroacoustic devices, including a speaker of the one or more speakers 474 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 478 can provide haptic events to respective haptic actuators that are capable of being sensed by a user of the watch body 420. In some embodiments, the one or more haptic controllers 478 can receive input signals from an application of the applications 482.

In some embodiments, the computer system 430 and/or the computer system 460 can include memory 480, which can be controlled by a memory controller of the one or more controllers 477 and/or one or more processors 479. In some embodiments, software components stored in the memory 480 include one or more applications 482 configured to perform operations at the watch body 420. In some embodiments, the one or more applications 482 include games, word processors, messaging applications, calling applications, web browsers, social media applications, media streaming applications, financial applications, calendars, clocks, etc. In some embodiments, software components stored in the memory 480 include one or more communication interface modules 483 as defined above. In some embodiments, software components stored in the memory 480 include one or more graphics modules 484 for rendering, encoding, and/or decoding audio and/or visual data; and one or more data management modules 485 for collecting, organizing, and/or providing access to the data 487 stored in memory 480. In some embodiments, software components stored in the memory 480 include an assistant specific module 486A, which is configured to perform the features described above in reference to FIGS. 1A-1F. In some embodiments, one or more of applications 482 and/or one or more modules can work in conjunction with one another to perform various tasks at the watch body 420.

In some embodiments, software components stored in the memory 480 can include one or more operating systems 481 (e.g., a Linux-based operating system, an Android operating system, etc.). The memory 480 can also include data 487. The data 487 can include profile data 488A, sensor data 489A, media content data 490, application data 491, and assistant specific data 492A, which stores data related to the performance of the features described above in reference to FIGS. 1A-2F.

It should be appreciated that the watch body computing system 460 is an example of a computing system within the watch body 420, and that the watch body 420 can have more or fewer components than shown in the watch body computing system 460, combine two or more components, and/or have a different configuration and/or arrangement of the components. The various components shown in watch body computing system 460 are implemented in hardware, software, firmware, or a combination thereof, including one or more signal processing and/or application-specific integrated circuits.

Turning to the wearable band computing system 430, one or more components that can be included in the wearable band 410 are shown. The wearable band computing system 430 can include more or fewer components than shown in the watch body computing system 460, combine two or more components, and/or have a different configuration and/or arrangement of some or all of the components. In some embodiments, all, or a substantial portion of the components of the wearable band computing system 430 are included in a single integrated circuit. Alternatively, in some embodiments, components of the wearable band computing system 430 are included in a plurality of integrated circuits that are communicatively coupled. As described above, in some embodiments, the wearable band computing system 430 is configured to couple (e.g., via a wired or wireless connection) with the watch body computing system 460, which allows the computing systems to share components, distribute tasks, and/or perform other operations described herein (individually or as a single device).

The wearable band computing system 430, similar to the watch body computing system 460, can include one or more processors 449, one or more controllers 447 (including one or more haptics controller 448), a peripherals interface 431 that can include one or more sensors 413 and other peripheral devices, power source (e.g., a power system 456), and memory (e.g., a memory 450) that includes an operating system (e.g., an operating system 451), data (e.g., data 454 including profile data 488B, sensor data 489B, Assistant Specific Data 492B, etc.), and one or more modules (e.g., a communications interface module 452, a data management module 453, an Assistant Specific Module 486B, etc.).

The one or more sensors 413 can be analogous to sensors 421 of the computer system 460 in light of the definitions above. For example, sensors 413 can include one or more coupling sensors 432, one or more SpO2 sensors 434, one or more EMG sensors 435, one or more capacitive sensors 436, one or more heart rate sensors 437, and one or more IMU sensors 438.

The peripherals interface 431 can also include other components analogous to those included in the peripheral interface 461 of the computer system 460, including an NFC component 439, a GPS component 440, an LTE component 441, a Wi-Fi and/or Bluetooth communication component 442, and/or one or more haptic devices 476 as described above in reference to peripherals interface 461. In some embodiments, the peripherals interface 431 includes one or more buttons 443, a display 433, a speaker 444, a microphone 445, and a camera 455. In some embodiments, the peripherals interface 431 includes one or more indicators, such as an LED.

It should be appreciated that the wearable band computing system 430 is an example of a computing system within the wearable band 410, and that the wearable band 410 can have more or fewer components than shown in the wearable band computing system 430, combine two or more components, and/or have a different configuration and/or arrangement of the components. The various components shown in wearable band computing system 430 can be implemented in one or a combination of hardware, software, and firmware, including one or more signal processing and/or application-specific integrated circuits.

The wrist-wearable device 400 with respect to FIGS. 4A is an example of the wearable band 410 and the watch body 420 coupled, so the wrist-wearable device 400 will be understood to include the components shown and described for the wearable band computing system 430 and the watch body computing system 460. In some embodiments, wrist-wearable device 400 has a split architecture (e.g., a split mechanical architecture or a split electrical architecture) between the watch body 420 and the wearable band 410. In other words, all of the components shown in the wearable band computing system 430 and the watch body computing system 460 can be housed or otherwise disposed in a combined watch device 400, or within individual components of the watch body 420, wearable band 410, and/or portions thereof (e.g., a coupling mechanism of the wearable band 410).

The techniques described above can be used with any device for sensing neuromuscular signals, including the arm-wearable devices of FIG. 4A, but could also be used with other types of wearable devices for sensing neuromuscular signals (such as body-wearable or head-wearable devices that might have neuromuscular sensors closer to the brain or spinal column).

In some embodiments, a wrist-wearable device 400 can be used in conjunction with a head-wearable device described below (e.g., AR device 500 and VR device 510) and/or an HIPD 600, and the wrist-wearable device 400 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 500 and VR device 510.

### Example Head-Wearable Devices

FIGS. 5A show example head-wearable devices, in accordance with some embodiments. Head-wearable devices can include, but are not limited to, AR devices 510 (e.g., AR or smart eyewear devices, such as smart glasses, smart monocles, smart contacts, etc.), VR devices 510 (e.g., VR headsets, head-mounted displays (HMD) s, etc.), or other ocularly coupled devices. The AR devices 500 and the VR devices 510 are instances of the head-wearable devices 110 described in reference to FIGS. 1A-2F herein, such that the head-wearable device should be understood to have the features of the AR devices 500 and/or the VR devices 510, and vice versa. The AR devices 500 and the VR devices 510 can perform various functions and/or operations associated with navigating through user interfaces and selectively opening applications, as well as the functions and/or operations described above with reference to FIGS. 1A-2F.

FIG. 5A further illustrates a computing system 520 and an optional housing 590, each of which show components that can be included in a head-wearable device (e.g., the AR device 500 and/or the VR device 510). In some embodiments, more or less components can be included in the optional housing 590 depending on practical restraints of the respective head- wearable device being described. Additionally or alternatively, the optional housing 590 can include additional components to expand and/or augment the functionality of a head-wearable device.

In some embodiments, the computing system 520 and/or the optional housing 590 can include one or more peripheral interfaces 522A and 522B, one or more power systems 542A and 542B (including charger input 543, PMIC 544, and battery 545), one or more controllers 546A 546B (including one or more haptic controllers 547), one or more processors 548A and 548B (as defined above, including any of the examples provided), and memory 550A and 550B, which can all be in electronic communication with each other. For example, the one or more processors 548A and/or 548B can be configured to execute instructions stored in the memory 550A and/or 550B, which can cause a controller of the one or more controllers 546A and/or 546B to cause operations to be performed at one or more peripheral devices of the peripherals interfaces 522A and/or 522B. In some embodiments, each operation described can occur based on electrical power provided by the power system 542A and/or 542B.

In some embodiments, the peripherals interface 522A can include one or more devices configured to be part of the computing system 520, many of which have been defined above and/or described with respect to wrist-wearable devices shown in FIG. 4A. For example, the peripherals interface can include one or more sensors 523A. Some example sensors include: one or more coupling sensors 524, one or more acoustic sensors 525, one or more imaging sensors 526, one or more EMG sensors 527, one or more capacitive sensors 528, and/or one or more IMUs 529. In some embodiments, the sensors 523A further include depth sensors 567, light sensors 568 and/or any other types of sensors defined above or described with respect to any other embodiments discussed herein.

In some embodiments, the peripherals interface can include one or more additional peripheral devices, including one or more NFC devices 530, one or more GPS devices 531, one or more LTE devices 532, one or more WiFi and/or Bluetooth devices 533, one or more buttons 534 (e.g., including buttons that are slidable or otherwise adjustable), one or more displays 535A, one or more speakers 536A, one or more microphones 537A, one or more cameras 538A (e.g., including the a first camera 539-1 through nth camera 539-n, which are analogous to the left camera 539A and/or the right camera 539B), one or more haptic devices 540; and/or any other types of peripheral devices defined above or described with respect to any other embodiments discussed herein.

The head-wearable devices can include a variety of types of visual feedback mechanisms (e.g., presentation devices). For example, display devices in the AR device 500 and/or the VR device 510 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 535A can be coupled to each of the lenses 506-1 and 506-2 of the AR device 500. The displays 535A coupled to each of the lenses 506-1 and 506-2 can act together or independently to present an image or series of images to a user. In some embodiments, the AR device 500 and/or the VR device 510 includes a single display 535A (e.g., a near-eye display) or more than two displays 535A.

In some embodiments, a first set of one or more displays 535A can be used to present an augmented-reality environment, and a second set of one or more display devices 535A can be used to present a virtual-reality environment. In some embodiments, one or more waveguides are used in conjunction with presenting artificial-reality content to the user of the AR device 500 and/or the VR device 510 (e.g., as a means of delivering light from a display projector assembly and/or one or more displays 535A to the user's eyes). In some embodiments, one or more waveguides are fully or partially integrated into the AR device 500 and/or the VR device 510. Additionally, or alternatively to display screens, some artificial-reality systems include one or more projection systems. For example, display devices in the AR device 500 and/or the VR device 510 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 535A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 535A for presenting information to users. For example, an external display 535A can be used to show a current battery level, network activity (e.g., connected, disconnected, etc.), current activity (e.g., playing a game, in a call, in a meeting, watching a movie, etc.), and/or other relevant information. In some embodiments, the external displays 535A can be used to communicate with others. For example, a user of the head-wearable device can cause the external displays 535A to present a do not disturb notification. The external displays 535A can also be used by the user to share any information captured by the one or more components of the peripherals interface 522A and/or generated by head-wearable device (e.g., during operation and/or performance of one or more applications).

The memory 550A can include instructions and/or data executable by one or more processors 548A (and/or processors 548B of the housing 590) and/or a memory controller of the one or more controllers 546A (and/or controller 546B of the housing 590). The memory 550A can include one or more operating systems 551; one or more applications 552; one or more communication interface modules 553A; one or more graphics modules 554A; one or more AR processing modules 555A; assistant specific module 556A configured to process sensor data associated with the assistant; and/or any other types of modules or components defined above or described with respect to any other embodiments discussed herein.

The data 560 stored in memory 550A can be used in conjunction with one or more of the applications and/or programs discussed above. The data 560 can include profile data 561; sensor data 562; media content data 563; AR application data 564; assistant specific data 565 for determining a hand gesture has been performed, the assistant is active, and/or sensor data is being captured; and/or any other types of data defined above or described with respect to any other embodiments discussed herein.

In some embodiments, the controller 546A of the head-wearable devices processes information generated by the sensors 523A on the head-wearable devices and/or another component of the head-wearable devices and/or communicatively coupled with the head-wearable devices (e.g., components of the housing 590, such as components of peripherals interface 522B). For example, the controller 546A can process information from the acoustic sensors 525 and/or imaging sensors 526. For each detected sound, the controller 546A can perform a direction of arrival (DOA) estimation to estimate a direction from which the detected sound arrived at a head-wearable device. As one or more of the acoustic sensors 525 detects sounds, the controller 546A can populate an audio data set with the information (e.g., represented by sensor data 562).

In some embodiments, a physical electronic connector can convey information between the head-wearable devices and another electronic device, and/or between one or more processors 548A of the head-wearable devices and the controller 546A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 600) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 500 and/or the VR device 510 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIG. 5A shows the VR device 510 having cameras 539-1-539-n, which can be used to provide depth information for creating a voxel field and a two-dimensional mesh to provide object information to the user to avoid collisions.

The optional housing 590 can include analogous components to those describe above with respect to the computing system 520. For example, the optional housing 590 can include a respective peripherals interface 522B including more or less components to those described above with respect to the peripherals interface 522A. As described above, the components of the optional housing 590 can be used augment and/or expand on the functionality of the head-wearable devices. For example, the optional housing 590 can include respective sensors 523B, speakers 536B, displays 535B, microphones 537B, cameras 538B, and/or other components to capture and/or present data. Similarly, the optional housing 590 can include one or more processors 548B, controllers 546B, and/or memory 550B (including respective communication interface modules 553B; one or more graphics modules 554B; one or more AR processing modules 555B, etc.) that can be used individually and/or in conjunction with the components of the computing system 520.

The techniques described above in FIG. 5A can be used with different head-wearable devices. In some embodiments, the head-wearable devices (e.g., the AR device 500 and/or the VR device 510) can be used in conjunction with one or more wearable device such as a wrist-wearable device 400 (or components thereof). Having thus described example the head-wearable devices, attention will now be turned to example handheld intermediary processing devices, such as HIPD 600.

### Example Handheld Intermediary Processing Devices

FIG. 6A illustrate an example handheld intermediary processing device (HIPD) 600, in accordance with some embodiments. The HIPD 600 is an instance of the intermediary device wrist-wearable device 170 described in reference to FIGS. 1A-2F herein, such that the HIPD 600 should be understood to have the features described with respect to any intermediary device defined above or otherwise described herein, and vice versa. The HIPD 600 can perform various functions and/or operations associated with navigating through user interfaces and selectively opening applications, as well as the functions and/or operations described above with reference to FIGS. 1A-2F.

FIG. 6A shows block diagrams of a computing system 640 of the HIPD 600, in accordance with some embodiments. The HIPD 600, described in detail above, can include one or more components shown in HIPD computing system 640. The HIPD 600 will be understood to include the components shown and described below for the HIPD computing system 640. In some embodiments, all, or a substantial portion of the components of the HIPD computing system 640 are included in a single integrated circuit. Alternatively, in some embodiments, components of the HIPD computing system 640 are included in a plurality of integrated circuits that are communicatively coupled.

The HIPD computing system 640 can include a processor (e.g., a CPU 677, a GPU, and/or a CPU with integrated graphics), a controller 675, a peripherals interface 650 that includes one or more sensors 651 and other peripheral devices, a power source (e.g., a power system 695), and memory (e.g., a memory 678) that includes an operating system (e.g., an operating system 679), data (e.g., data 688), one or more applications (e.g., applications 680), and one or more modules (e.g., a communications interface module 681, a graphics module 682, a task and processing management module 683, an interoperability module 684, an AR processing module 685, a data management module 686, an assistant specific module 687, etc.). The HIPD computing system 640 further includes a power system 695 that includes a charger input and output 696, a PMIC 697, and a battery 698, all of which are defined above.

In some embodiments, the peripherals interface 650 can include one or more sensors 651. The sensors 651 can include analogous sensors to those described above in reference to FIG. 4A. For example, the sensors 651 can include imaging sensors 654, (optional) EMG sensors 656, IMUs 658, and capacitive sensors 660. In some embodiments, the sensors 651 can include one or more pressure sensor 652 for sensing pressure data, an altimeter 653 for sensing an altitude of the HIPD 600, a magnetometer 655 for sensing a magnetic field, a depth sensor 657 (or a time-of flight sensor) for determining a difference between the camera and the subject of an image, a position sensor 659 (e.g., a flexible position sensor) for sensing a relative displacement or position change of a portion of the HIPD 600, a force sensor 661 for sensing a force applied to a portion of the HIPD 600, and a light sensor 662 (e.g., an ambient light sensor) for detecting an amount of lighting. The sensors 651 can include one or more sensors not shown in FIG. 6A.

The peripherals interface 650 can also include an NFC component 663, a GPS component 664, an LTE component 665, a Wi-Fi and/or Bluetooth communication component 666, a speaker 669, a haptic device 671, and a microphone 673. The HIPD 600 can optionally include a display 668 and/or one or more buttons 667. The peripherals interface 650 can further include one or more cameras 670, touch surfaces 672, and/or one or more light emitters 674. The multi-touch input surface described in reference to FIG. 6A is an example of touch surface 672. The light emitters 674 can be one or more LEDs, lasers, etc. and can be used to project or present information to a user. For example, the light emitters 674 can include light indicators. The cameras 670 can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 670 can be used for SLAM; 6 DoF ray casting, gaming, object manipulation, and/or other rendering; facial recognition and facial expression recognition, etc.

Similar to the watch body computing system 460 and the watch band computing system 430 described above in reference to FIG. 4A, the HIPD computing system 640 can include one or more haptic controllers 676 and associated componentry (e.g., haptic devices 671) for providing haptic events at the HIPD 600.

Memory 678 can include high-speed random-access memory and/or non-volatile memory, such as one or more magnetic disk storage devices, flash memory devices, or other non-volatile solid-state memory devices. Access to the memory 678 by other components of the HIPD 600, such as the one or more processors and the peripherals interface 650, can be controlled by a memory controller of the controllers 675.

In some embodiments, software components stored in the memory 678 include one or more operating systems 679, one or more applications 680, one or more communication interface modules 681, one or more graphics modules 682, one or more data management modules 683, which are analogous to the software components described above in reference to FIG. 4A. The software components stored in the memory 678 can also include an assistant specific module 687, which is configured to perform the features described above in reference to FIGS. 1A-2F.

In some embodiments, software components stored in the memory 678 include a task and processing management module 683 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 683 uses data 688 (e.g., device data 690) to distribute the one or more front-end and/or back-end tasks based on communicatively coupled devices' computing resources, available power, thermal headroom, ongoing operations, and/or other factors. For example, the task and processing management module 683 can cause the performance of one or more back-end tasks (of an operation performed at communicatively coupled AR device 500) at the HIPD 600 in accordance with a determination that the operation is utilizing a predetermined amount (e.g., at least 70%) of computing resources available at the AR device 500.

In some embodiments, software components stored in the memory 678 include an interoperability module 684 for exchanging and utilizing information received and/or provided to distinct communicatively coupled devices. The interoperability module 684 allows for different systems, devices, and/or applications to connect and communicate in a coordinated way without user input. In some embodiments, software components stored in the memory 678 include an AR module 685 that is configured to process signals based at least on sensor data for use in an AR and/or VR environment. For example, the AR processing module 685 can be used for 3D object manipulation, gesture recognition, facial and facial expression, recognition, etc.

The memory 678 can also include data 688, including structured data. In some embodiments, the data 688 can include profile data 689, device data 690 (including device data of one or more devices communicatively coupled with the HIPD 600, such as device type, hardware, software, configurations, etc.), sensor data 691, media content data 692, application data 693, and Assistant Specific Data 694, which stores data related to the performance of the features described above in reference to FIGS. 1A-2F.

It should be appreciated that the HIPD computing system 640 is an example of a computing system within the HIPD 600, and that the HIPD 600 can have more or fewer components than shown in the HIPD computing system 640, combine two or more components, and/or have a different configuration and/or arrangement of the components. The various components shown in HIPD computing system 640 are implemented in hardware, software, firmware, or a combination thereof, including one or more signal processing and/or application-specific integrated circuits.

The techniques described above in FIG. 6A can be used with any device used as a human-machine interface controller. In some embodiments, an HIPD 600 can be used in conjunction with one or more wearable device such as a head-wearable device (e.g., AR device 500 and VR device 510) and/or a wrist-wearable device 400 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including instructions that, when executed by a computer system including a wrist-wearable device and/or a head-wearable device worn by a user, cause the computer system to perform or cause performance of:
in accordance with a determination that a hand gesture performed by a user wearing the head-wearable device and the wrist-wearable device is maintained:
capturing sensor data using one or more sensors, and
initiating an assistant associated with the head-wearable device and/or wrist-wearable device;
in accordance with a determination that the hand gesture is no longer maintained, ceasing to capture sensor data via the one or more sensors; and
presenting, by the assistant, a response to the user based on the sensor data, wherein the response includes one or more of characterization of, by the assistant:
i) a scene within the sensor data, and
ii) one or more objects within the sensor data.

2. The non-transitory, computer-readable storage medium of claim 1, wherein the instructions, when executed by the computer system, further cause the computer system to perform operations comprising:
presenting, via a display communicatively coupled with the wrist-wearable device and/or the head-wearable device, at least one user interface element, the at least one user interface element corresponding to performing an operation recommended by the assistant, the operation including one or more of an internet search on the sensor data, presenting a store front associated with an object included in the sensor data, purchasing an object included in the sensor data, sharing the sensor data, modifying the sensor data, and storing the sensor data.

3. The non-transitory, computer-readable storage medium of claim 1, wherein the response to the user further includes an assistant generated explication of the scene and/or the one or more objects, the assistant generated explication comprising an analysis of the scene and/or the one or more objects and additional data stored at the wrist-wearable device and/or the head-wearable device.

4. The non-transitory, computer-readable storage medium of claim 1, wherein the instructions, when executed by computer system, further cause the computer system to perform operations comprising:
presenting, via a display, a user interface element that when selected is configured to cause the assistant to audibly narrate the response to the user.

5. The non-transitory, computer-readable storage medium of claim 1, wherein the response to the user further includes sharing sensor data with an application that is active while the user is performing the hand gesture.

6. The non-transitory, computer-readable storage medium of claim 1, wherein the sensor data includes a user query.

7. The non-transitory, computer-readable storage medium of claim 1, wherein presenting the response includes providing an indication to the user, the indication including at least one of an auditory, a visual, and/or a haptic indication.

8. A method, comprising:
at a head-wearable device and/or a wrist-wearable device:
in accordance with a determination that a hand gesture performed by a user wearing the head-wearable device and the wrist-wearable device is maintained:
capturing sensor data using one or more sensors, and
initiating an assistant associated with the head-wearable device and/or wrist-wearable device;
providing an indication to the user that the assistant is using the sensor data; and
in accordance with a determination that the hand gesture is no longer maintained:
ceasing to capture sensor data via the one or more sensors, and
providing, by the assistant, a response to the user based on the sensor data, wherein the response includes one or more of:
i) characterization of a scene within the sensor data; and
ii) identification of one or more objects within the sensor data.

9. The method of claim 8, wherein presenting, via a display communicatively coupled with the wrist-wearable device and/or the head-wearable device, at least one user interface element, the at least one user interface element corresponding to performing an operation recommended by the assistant, the operation including one or more of an internet search on the sensor data,
presenting a store front associated with an object included in the sensor data, purchasing an object included in the sensor data, sharing the sensor data, modifying the sensor data, and storing the sensor data.

10. The method of claim 8, wherein the response to the user further includes an assistant generated explication of the scene and/or the one or more objects, the assistant generated explication comprising an analysis of the scene and/or the one or more objects and additional data stored at the wrist-wearable device and/or the head-wearable device.

11. The method of claim 8, wherein presenting, via a display, a user interface element that when selected is configured to cause the assistant to audibly narrate the response to the user.

12. The method of claim 8, wherein the response to the user further includes sharing sensor data with an application that is active while the user is performing the hand gesture.

13. The method of claim 8, wherein presenting the response includes providing an indication to the user, the indication including at least one of an auditory, a visual, and/or a haptic indication.

14. The method of claim 8, wherein the sensor data includes a user query.

15. An electronic device, comprising:
one or more programs, wherein the one or more programs are stored in memory and configured to be executed by one or more processors, the one or more programs including instructions for:
at a head-wearable device and/or a wrist-wearable device:
in accordance with a determination that a hand gesture performed by a user wearing the head-wearable device and the wrist-wearable device is maintained:
capturing sensor data using one or more sensors, and
initiating an assistant associated with the head-wearable device and/or wrist-wearable device;
providing an indication to the user that the assistant is using the sensor data; and
in accordance with a determination that the hand gesture is no longer maintained:
ceasing to capture sensor data via the one or more sensors, and
providing, by the assistant, a response to the user based on the sensor data, wherein the response includes one or more of:
i) characterization of a scene within the sensor data; and
ii) identification of one or more objects within the sensor data.

16. The electronic device of claim 15, wherein the one or more programs further include instructions for:
presenting, via a display communicatively coupled with the wrist-wearable device and/or the head-wearable device, at least one user interface element, the at least one user interface element corresponding to performing an operation recommended by the assistant, the operation including one or more of an internet search on the sensor data, presenting a store front associated with an object included in the sensor data, purchasing an object included in the sensor data, sharing the sensor data, modifying the sensor data, and storing the sensor data.

17. The electronic device of claim 15, wherein the response to the user further includes an assistant generated explication of the scene and/or the one or more objects, the assistant generated explication comprising an analysis of the scene and/or the one or more objects and additional data stored at the wrist-wearable device and/or the head-wearable device.

18. The electronic device of claim 15, wherein the one or more programs further include instructions for:
presenting, via a display, a user interface element that when selected is configured to cause the assistant to audibly narrate the response to the user.

19. The electronic device of claim 15, wherein the response to the user further includes sharing sensor data with an application that is active while the user is performing the hand gesture.

20. The electronic device of claim 15, wherein presenting the response includes providing an indication to the user, the indication including at least one of an auditory, a visual, and/or a haptic indication.
